(19) United States
(12) Patent Application Publication
(10) Pub. No.: US 2014/0145368 A1
(43) Pub. Date: May 29, 2014

(54) METHOD FOR PRODUCING FLEXOGRAPHIC PLATE ORIGINAL FOR LASER ENGRAVING

(71) Applicants: Chikao Ohashi, Okazaki--shi (JP); Michihiko Ichikawa, Okazaki-shi (JP); Hisao Yamamoto, Haibara-gun (JP)

(72) Inventors: Chikao Ohashi, Okazaki--shi (JP); Michihiko Ichikawa, Okazaki-shi (JP); Hisao Yamamoto, Haibara-gun (JP)

(73) Assignees: FUJI-FILM CORPORATION, TOKYO (JP); TORAY INDUSTRIES, INC., TOKYO (JP)

(21) Appl. No.: 13/825,169

(22) PCT Filed: Sep. 28, 2011
(86) PCT No.: PCT/JP2011/072276

§ 371 Date: May 30, 2013

(30) Foreign Application Priority Data
Sep. 30, 2010 (JP) 2010-222417

(51) Int. Cl. B41C 1/05

(52) U.S. Cl. CPC B41C 1/05
USPC 264/234; 264/319; 264/331.15; 264/330

(57) ABSTRACT

A method is provided for production of a flexographic printing plate precursor for laser engraving including at least the following steps to be carried out in this order: (1) a step for separately preparing a plurality of fluids that are reactive with each other, (2) a step for carrying out in-line mixing of the plurality of fluids to form a reactive resin composition, (3) a step for casting the reactive resin composition onto a release material to form a cast film, (4) a step for heating the cast film, and (5) a step for removing the cast film from the release material to form an independent sheet made of the reactive resin composition.

### CROSS REFERENCE TO RELATED APPLICATIONS

This application is the U.S. National Phase application of PCT/JP2011/072276, filed Sep. 28, 2011, and claims priority to Japanese Patent Application No. 2010-222417, filed Sep. 30, 2010, the disclosures of both applications being incorporated herein by reference in their entireties for all purposes.

### FIELD OF THE INVENTION

The present invention relates to a method for production of flexographic printing plate precursors for laser engraving.

### BACKGROUND OF THE INVENTION

As a method for producing a flexographic printing plate whose surface has raised portions (in relief), the analog plate making process has been well known which includes the steps of exposing a flexographic printing plate precursor containing a photosensitivity resin composition to ultraviolet light through a photographic original picture film, curing image-containing portions selectively, and removing the uncured portions using a developer. The analog plate making process requires a photographic original picture film that contains silver salt based material, and accordingly, much production time and cost for photographic original picture film. In view of environmental sanitation, furthermore, this is disadvantageous in that the development of photographic original picture films requires chemical treatment and waste liquid from development also requires treatment. Thus, a process that uses laser engraving to produce a relief pattern has been proposed in recent years.

For instance, there is a proposed technique that irradiates ultraviolet light to a photosensitive flexographic printing plate precursor and engraves the photo-cured precursor using carbon dioxide gas laser to produce a relief for printing (see, for instance, patent document 1). However, this technique has a problem of being low in engraving sensitivity. In order to enhance the engraving sensitivity, it has been proposed to add an infrared absorbing substance to an elastomer layer to be laser-engraved (see, for instance, patent documents 2 to 3). Substances of this type, such as carbon black, have an ultraviolet light absorption function as well and therefore, it is difficult for ultraviolet light to photo-cure an elastomer layer across its entire thickness. Thus, it has been proposed to add a thermal polymerization initiator to the elastomer layer to achieve thermal crosslinking of this layer.

So far, several methods have been proposed for production of flexographic printing plate precursors for laser engraving. For instance, they include the process of melt-extruding a crosslinkable resin composition onto a support, the process of flow-casting a solution of a crosslinkable resin composition onto a support, followed by drying to remove the solvent (see, for instance, patent documents 4 to 5), and the process of casting a crosslinkable resin composition onto a release material, drying the cast film to separate it as an independent sheet, and combining the independent sheet with a support (see, for instance, patent document 6). Another proposed process consists of the steps of forming a supply layer and a multi-layered composite layer containing an uncrosslinked precursory material layer that serves to produce a relief formation layer located adjacent to the supply layer, diffusing a thermal polymerization initiator from the supply layer into the precursory material layer, and thermally crosslinking the precursory material layer to produce a relief formation layer (see, for instance, patent document 7).

### PATENT DOCUMENTS

### Patent Document 1

U.S. Pat. No. 5,259,311 Specification (Claims)

### Patent Document 2

### Published Japanese Translation of PCT International Publication Hei 7-506780 (p. 5 and p. 8)

### Patent Document 3

### Published Japanese Translation of PCT International Publication HEI 7-505840 (p. 7, p. 11, and p. 12)

### Patent Document 4

### Japanese Unexamined Patent Publication (Kokai) 2006-2061 (p. 10, p. 16, and p. 17)

### Patent Document 5

### Japanese Unexamined Patent Publication (Kokai) 2008-229875 (pp. 7-10)

### Patent Document 6

### Japanese Unexamined Patent Publication (Kokai) 2010-234636 (Claims)

### Patent Document 7

### Published Japanese Translation of PCT International Publication 2004-522618 (Claims)

### SUMMARY OF THE INVENTION

It has been difficult, however, for the processes described in patent documents 2 and 3 to perform stable production because thermal crosslinking can take place too rapidly due to high temperatures and shear stresses required in forming an elastomer layer using a kneader or twin-screw extruder. It is also difficult for the processes described in patent documents 4 to 6 to produce a reactive resin composition in a thermally stable manner. The process described in patent document 7 is not suitable for stable production because it is difficult to accurately control the diffusion from the supply layer to the precursory material layer.

Thus, the present invention aims to provide a process that can perform stable production of a flexographic printing plate precursor for laser engraving.

The process for production of a flexographic printing plate precursor for laser engraving according to embodiments of the present invention is characterized in that at least the undermentioned steps (1) to (5) are carried out in this order.

(1) A step for separately preparing a plurality of fluids that are reactive with each other,
(2) A step for carrying out in-line mixing of the plurality of fluids to form a reactive resin composition,
(3) A step for casting the reactive resin composition onto a release material to form a cast film,
(4) A step for heating the cast film, and
(5) A step for peeling off the cast film from the release material to form an independent sheet made of the reactive resin composition.

It is preferable that the process further include a step (6) for heating the independent sheet after step (5).

It is preferable that the plurality of fluids include a fluid containing an ethylenically unsaturated monomer and a fluid containing a thermal polymerization initiator. Alternately, it is preferable that the plurality of fluids include a fluid containing a hydroxyl group-containing compound and a fluid containing a crosslinking agent that reacts with the hydroxyl group.

According to the present invention, the thermal stability of the reactive resin composition is improved greatly to permit stable production of a flexographic printing plate precursor for laser engraving.

### BRIEF DESCRIPTION OF THE DRAWINGS

FIG. 1 is a schematic diagram illustrating, as an example, a step (1), a step (2), and a step (3) that constitute part of the present invention.

FIG. 2 is a schematic diagram illustrating, as an example, a step (5) and a step (6) that constitute another part of the present invention.

FIG. 3 is a schematic diagram illustrating, as an example, an arbitrary step (7).

FIG. 4 is a schematic diagram illustrating, as an example, an arbitrary step (8).

### DETAILED DESCRIPTION OF EMBODIMENTS OF THE INVENTION

The flexographic printing plate precursor for laser engraving according to the present invention has at least an engraving layer to be engraved. If necessary, it may have a support, and the surface of the engraving layer may be provided with a temporary support. An adhesion layer may be provided, furthermore, between the support and the engraving layer, and a slip coat layer may be provided between the engraving layer and the temporary support in order to allow the temporary support to be peeled off easily from the engraving layer.

The present invention provides a process for stable production of an engraving layer that serves as a functional layer in a flexographic printing plate precursor for laser engraving. The flexographic printing plate precursor commonly has a large thickness in the range of 0.5 mm to 7 mm, and the thickest layer that occupies a large portion of the flexographic printing plate precursor, that is, the engraving layer for the present invention, also has a large thickness of 0.4 mm to 6 mm in most cases. The following embodiment is proposed as a method to produce an engraving layer that is in the form of a thick film as described above.

The method for production of a flexographic printing plate precursor for laser engraving according to embodiments of the present invention includes at least the following steps in this order:

(1) a step for separately preparing a plurality of fluids that are reactive with each other,
(2) a step for carrying out in-line mixing of the plurality of fluids to form a reactive resin composition,
(3) a step for casting the reactive resin composition onto a release material to form a cast film,
(4) a step for heating the cast film, and
(5) a step for peeling off the cast film from the release material to form an independent sheet made of the reactive resin composition.

The reactive resin compositions referred to herein is a composition that undergoes polymerization reaction, condensation reaction, and/or crosslinking reaction caused by the action of light, heat, electron beam, or the like. It is preferable that such reactive resin compositions contain a solvent because there will be a wider range of choices. If the reactive resin composition contains a solvent, furthermore, the reactive resin composition can be mixed at a lower temperature, serving for more stable production of the reactive resin composition. It is preferable that the solvent content in the reactive resin composition is 70 wt % or less so that the solvent removal time can be decreased enough to meet the production process requirements. It is more preferable that the solvent content is 5 wt % to 50 wt %. It is preferable that the solvent has a boiling point of 200° C. or less under atmospheric pressure because it will be easy to remove the solvent to ensure lower production costs. It is more preferable that the solvent has a boiling point of 110° C. or less under atmospheric pressure. Solvents having a boiling point of 200° C. or less under atmospheric pressure include, for instance, water, methanol, ethanol, n-propanol, isopropanol, n-butanol, sec-butanol, tert-butanol, tetrahydrofuran, methyl ethyl ketone, methyl isobutyl ketone, propylene glycol monomethyl ether, propylene glycol monomethyl ether monoacetate, toluene, xylene, methyl acetate, and ethyl acetate. As the aforementioned solvent, one solvent selected from the above may be contained. Alternatively, two or more selected from these solvents may be contained. Solvents having a boiling point higher than 200° C. under atmospheric pressure may be contained, but it is preferable that their total solvent content is 10 wt % or less in view of the volatilization efficiency of such solvents.

The reactive resin composition is described in detail below.

An engraving layer is required to have the following main functions: (A) ink resistance, (B) laser-engravability, and (C) printing durability. For the present invention, an engraving layer is produced from a reactive resin composition, and accordingly, the reactive resin composition is designed so as to maintain the functions listed above.

(A) If an engraving layer is formed of an ink resistant reactive resin composition, the engraving layer will undergo no change in physical properties, or little change in physical properties, during flexographic printing, allowing the printing to be continued stably for a long period. It is preferable that the engraving layer does not swell, or swells little, when coming in contact with a type of ink that is commonly used for flexographic printing (such as aqueous ink, UV ink, and solvent ink). It is preferable that a reactive resin composition is such that after immersion treatment of an engraving layer in a predetermined type of ink at 30° C. for 24 hours, its percent changes in weight, thickness, and hardness are all within ±10%. The hardness of an engraving layer is represented in terms of Shore A hardness, which is generally used to measure the hardness of flexographic plates, and can be determined by means of a Shore A hardness tester.

A method to depress swelling of an engraving layer is to use a reactive resin composition comprising a main component polymer that differs in polarity from the ink to be used. The main component polymer as referred to herein is the polymer species that accounts for 50 wt % or more of the total weight (which accounts for 100 wt %) of the polymers contained in a reactive resin composition. For instance, (i) an engraving layer having aqueous ink resistance can be produced by using a water insoluble plastomer or a water insoluble elastomer as main component polymer.

Useful water insoluble plastomers include, for instance, polyvinyl acetal, such as polyvinyl butyral, acrylic resin, polyvinyl chloride (PVC), polycarbonate (PC), polyamide (PA), methacrylate-styrene copolymer (MS resin), ethylene-vinyl acetate copolymer (EVA resin), and petroleum resin. Two or more of them may be used in combination.

Useful water insoluble elastomers include, for instance, synthetic rubbers such as butadiene rubber, nitrile rubber, styrene butadiene rubber, isoprene rubber, and butyl rubber, and thermoplasticity elastomers such as styrene/butadiene/styrene block copolymer (SBS), and styrene/isoprene/styrene block copolymer (SIS). Two or more of them may be used in combination.

(ii) An engraving layer having UV ink resistance can be produced by using one of the above mentioned water insoluble plastomers and water insoluble elastomers as main component polymer, or by using soluble resin, such as water-soluble or water-swellable polyamide and partially saponified polyvinyl alcohol, as main component polymer. Most UV inks are solvent-free, and there are a relatively wide variety of polymers that can be applied, but the type of monomer used as the main component in UV ink varies among ink manufacturers and products. A suitable main component polymer should be selected to meet the properties of the ink to be used. With high hydrogen bonding strength, partially saponified polyvinyl alcohol, which is a water soluble resin, has resistance to many monomers and therefore, can be used favorably as main component polymer for UV ink resistant applications. Such partially saponified polyvinyl alcohols may have hydroxyl groups at least partly modified, and polymers in which at least part of the hydroxyl groups are modified into (meth)acryloyl groups are used particularly favorably. This is because direct introduction of an unreacted crosslinkable functional group into a polymer serves to increase the strength of an engraving layer without using a large amount of a polyfunctional monomer as an ethylenically unsaturated monomer as described later, leading to easy production of an engraving layer having both flexibility and strength.

From the viewpoint of improving ink resistance, it is preferable that the content of the main component polymer in a reactive resin composition is 15 wt % or more, more preferably 20 wt % or more, of the total weight of the solid components in the reactive resin composition. From the viewpoint of flexibility, on the other hand, it is preferable that the content is 80 wt % or less, more preferably 65 wt % or less, of the total weight of the solid components in the reactive resin composition.

A reactive resin composition may contain a polymer other than the main component polymer described above. From the viewpoint of preventing cold flow in the precursor, it is preferable that the total polymer content in this case is 20 wt % or more, more preferably 25 wt % or more, of the total weight of the solid components in the reactive resin composition. From the viewpoint of printing durability, on the other hand, it is preferable that the content is 80 wt % or less, more preferably 70 wt % or less.

(B) Laser engravability is defined as the ability to be engraved by a laser designed for engraving, and it can be developed by, for instance, adding an absorbent for light in the laser wavelength region to an engraving layer. A laser absorbent converts light energy of a laser beam into heat energy, and this heat energy works to promote heat decomposition of the engraving layer.

A carbon dioxide gas laser has a wavelength region around 11 μm, and most polymers absorb light in this wavelength region, indicating that it is not always necessary to add a laser absorbent. Compared to this, near infrared lasers such as semiconductor laser, YAG laser, and fiber laser have an oscillation wavelength of 780 to 1,300 nm, and there are not many polymers that absorb light in this wavelength region. It is preferable therefore that a polymer to be used to produce a material for laser engraving by a near infrared laser contains a laser light absorbent.

Useful laser light absorbents include, for instance, pigments such as carbon black, phthalocyanine compound, and cyanine compounds; dyes such as squarylium dye, polymethine dye, and nigrosine dye; and powder of metals such as chrome oxide, iron oxide, iron, aluminum, copper, and zinc. Of these laser light absorbents, carbon black has been preferred because of its low price and high stability. Any carbon black product can be used regardless of the ASTM-specified category it belongs to or applications it is intended for (for example, coloring, rubber products, dry batteries) as long as it can disperse stably in the composition. Carbon black products include, for instance, furnace black, thermal black, channel black, lamp black, and acetylene black.

The pigments, such as carbon black, and metal powder may contain a dispersing agent as required to promote their dispersion, and they may be in the form of colored chips or colored paste produced by dispersing them in a binder such as cellulose nitrate. Such materials are widely available as commercial products.

In pigments, main particles generally, tend to coagulate to form stable secondary particles. It is preferable that such secondary pigment particles have a diameter of 0.01 μm or more from the viewpoint of dispersion stability improvement in a reactive resin composition, and more preferably the secondary pigment particles have a diameter of 0.05 μm or more. From the viewpoint of uniformity of the engraving layer, on the other hand, it is preferable that the diameter is 10 μm or less, more preferably 2 μm or less.

For dispersion of pigments, generally known dispersion techniques for production of ink or toner products can be used. Useful dispersion devices include, for instance, ultrasonic dispersion machine, sand mill, attritor, pearl mill, super mill, ball mill, impeller, disperser, KD mill, colloid mill, dynatron, triple roll mill, and compression kneader.

Dispersion of pigments is achieved by adding a dispersing agent as required, and a well-known method is to use a pigment-dispersed liquid produced in advance by adding a solvent and binder as vehicle for spreading the pigment. A solvent and binder of an appropriate type to be used as vehicle may be selected arbitrarily as long as the pigment-dispersed liquid has a high dispersibility, but in view of dispersion stability of the pigment-dispersed liquid being added to a reactive resin composition, it is preferable that the binder used is the same polymer or a polymer of the same type as the aforementioned main component polymer, and it is preferable that the solvent used is the same as that used in the reactive resin composition or a solvent that is high in compatibility therewith.

(C) Printing durability is defined as the mechanical strength to resist printing, and the use of a flexographic printing plate with printing durability makes it possible to obtain prints stably through long-time printing without breakage or scraping of relief patterns.

To impart printing durability to an engraving layer, a useful method is, for instance, to introduce a crosslinked structure into the engraving layer. Useful techniques to achieve this include, for instance, (i) adding an ethylenically unsaturated monomer and a polymerization initiator to the reactive resin composition used for formation of an engraving layer and polymerizing the ethylenically unsaturated monomer by applying light or heat as a trigger, and (ii) adding a hydroxyl group-containing compound and a crosslinking agent reactive with the hydroxyl group to the reactive resin composition used for formation of an engraving layer and subjecting them to thermal reaction.

The ethylenically unsaturated monomer has at least one ethylenically unsaturated double bond that can serve for polymerization and it is preferable that it has high compatibility with the polymer components described above. A preferred ethylenically unsaturated monomer generally has a boiling point of 150° C. or more under atmospheric pressure and a weight-average molecular weight of 3,000 or less, more preferably 2,000 or less. Preferred ethylenically unsaturated monomers include, for instance, esters or amides of (meth)acrylic acid with monofunctional or polyfunctional alcohol, amine, aminoalcohol, hydroxyether, hydroxyester. Examples include polyethylene glycol (meth)acrylate, glycerin di(meth)acrylate, and 1,6-hexanediol di(meth)acrylate. Two or more thereof may be contained. It should be noted that for the present invention, (meth)acrylates refer collectively to both acrylates and methacrylates.

From the viewpoint of printing durability, it is preferable that the content of the ethylenically unsaturated monomer in a reactive resin composition is 5 wt % or more, more preferably 10 wt % or more, of the total weight of the solid components in the reactive resin composition. From the viewpoint of flexibility, on the other hand, it is preferable that the content is 60 wt % or less, more preferably 40 wt % or less, of the total weight of the solid components in the reactive resin composition.

A polymerization initiator acts to initiate the crosslinking of the ethylenically unsaturated monomer, and if a crosslinkable functional group has been introduced into the polymer, the initiator also serves for its crosslinking. Useful polymerization initiators include, for instance, (a) photopolymerization initiators that cause formation of radicals when irradiated with an active ray such as ultraviolet light and (b) thermal polymerization initiators that cause formation of radicals when heated. When carbon black is contained as laser absorbent, in particular, it is preferable that (b) a thermal polymerization initiator is used because carbon black not only absorbs laser beams but also blocks active rays.

Preferred materials used as (a) photopolymerization initiator include, for instance, acetophenone compounds such as diethoxy acetophenone, benzyl dimethyl ketal, 1-hydroxycyclohexyl-phenyl ketone; benzoin based compounds such as benzoin, benzoin ethyl ether, benzoin isopropyl ether, and benzoin isobutyl ether; benzophenone based compounds such as benzophenone, methyl ortho-benzoylbenzoate, and 4-benzoyl-4′-methyl-diphenyl sulfide; thioxanthone based compounds such as 2-isopropyl thioxanthone, 2,4-diethyl thioxanthone, and 2,4-dichlorothioxanthone; amine based compounds such as triethanol amine, triisopropanol amine, ethyl 4-dimethyl aminobenzoate, 4,4′-bisdiethyl aminobenzophenone, 4,4′-bisdimethyl aminobenzophenone (Michler's ketone); benzyl based compounds such as benzyl dimethyl ketal; and others such as camphor quinone, 2-ethyl anthraquinone, and 9,10-phenanthrene quinone. Two or more thereof may be contained.

Preferred materials used as (b) thermal polymerization initiator include, for instance, peroxides such as acetyl peroxide, cumyl peroxide, tert-butyl peroxide, benzoyl peroxide, lauroyl peroxide, potassium persulfate, diisopropyl peroxycarbonate, tetralin hydroperoxide, tert-butyl hydroperoxide, tert-butyl peracetate, and tert-butyl perbenzoate; azo compounds such as 2,2′-azo bispropane, 1,1′-azo (methyl ethyl) diacetate, 2,2′-azo bisisobutyl amide, and 2,2′-azobisisobutyronitrile; and others such as benzenesulfonyl azide, and 1,4-bis(pentamethylene)-2-tetrazene. Two or more thereof may be contained.

From the viewpoint of increasing the crosslinking rate of an engraving layer, it is preferable that the content of the polymerization initiator in a reactive resin composition is 0.01 wt % or more, more preferably 0.1 wt % or more, of the total weight of the solid components in the reactive resin composition. From the viewpoint of printing durability, on the other hand, it is preferable that the content is 10 wt % or less, more preferably 3 wt % or less, of the total weight of the solid components in the reactive resin composition.

When the reactive resin composition contains a hydroxyl group-containing compound and its crosslinking agent, the hydroxyl group-containing compound may be a polymer or an additive such as a plasticizer as described below, but it is preferable that the hydroxyl group-containing compound is a polymer because the sheet obtained after crosslinking will have elastic properties. Use of a hydroxyl group-containing compound that has a relatively high molecular weight, for instance, a weight average molecular weight of 1,000 or more, serves to ensure a required strength while maintaining the number of crosslinking points at a moderately level. Such hydroxyl group-containing polymers include, for instance, partially saponified polyvinyl alcohol, and polyvinyl butyral.

The crosslinking agent that is reactive with a hydroxyl group reacts with the aforementioned hydroxyl group-containing compound to form a crosslinked structure, and it is a compound having two or more functional groups that are reactive with the hydroxyl group. The functional groups that are reactive with a hydroxyl group include, for instance, carboxyl group, isocyanate group, alkoxy silyl group, and alkoxy group.

The crosslinking agents that are reactive with the hydroxyl group include, for instance, polyfunctional carboxylic acids such as succinic acid, adipic acid, maleic acid, and fumaric acid; polyfunctional isocyanates such as HMDI (hexamethylene diisocyanate), TDI (tolylene diisocyanate), and MDI (diphenyl methane diisocyanate); polyfunctional blocked isocyanates produced by blocking these isocyanates with alcohol; silane coupling agents such as tetraethoxysilane; and metal chelate compounds such as tetrabutoxy titanium.

Catalysts including acids, alkalis, and amines or metal catalysts such as DBTDA (dibutyltin dicetate) may be added in order to promote the reaction of the crosslinking agent with the hydroxyl group-containing compound and hydroxyl group.

The reactive resin composition may contain, as required, a plasticizer for imparting flexibility and a polymerization inhibitor and thermal stabilizer for obtaining heat stability and may contain other additives such as surfactant, light absorbent, and dye.

Described below is the production method for a flexographic printing plate precursor for laser engraving according to an embodiment of the present invention. A reactive resin composition used for the present invention is designed so as to introduce a crosslinked structure in the engraving layer with the aim of imparting printing durability to the engraving layer, and crosslinking reaction of a reactive resin composition is induced by, for instance, light or heat. When the crosslinking reaction is a photoreaction, it is preferable that the photocrosslinking reaction takes place with as low energy irradiation as possible, while when it is a thermal reaction, it is preferable that the thermal crosslinking reaction takes place at as low a temperature as possible, in order to ensure a high production efficiency. Compared to this, from the viewpoint of production stability, it is preferable that such reactions so not take place under the storage conditions of the reactive resin composition, and accordingly, it is preferable that the viscosity increase rate is 10% or less in 24 hours. A required production efficiency and production stability can be maintained simultaneously in some cases by adding a polymerization inhibitor, storing the reactive resin composition in a lightproof environment to prevent photoreaction (in the case of a photoreactive composition), or storing the reactive resin composition at a temperature lower than the heat reaction temperature (in the case of a heat-reactive composition). However, the aforementioned methods to maintain both production efficiency and production stability decreases the scope of composition design, and in the case of a thermal reaction, in particular, the thermal reaction often cannot be inhibited sufficiently by simply lowering the storage temperature, depending on the required activation energy. In the process proposed herein for the present invention, the components of a reactive resin composition are divided into two or more groups, and each group is prepared separately and combined together by in-line mixing immediately before being cast onto a release material to form a reactive resin composition.

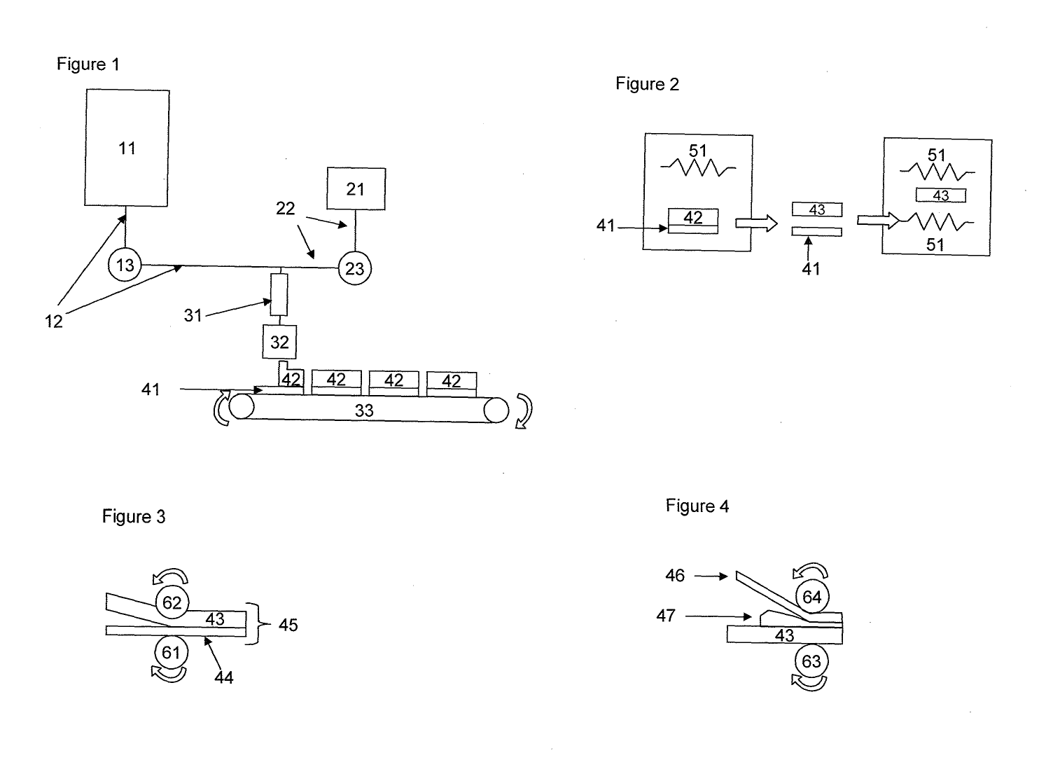

FIG. 1 gives a schematic diagram illustrating the steps for (1) separately preparing a plurality of fluids that are reactive with each other, (2) carrying out in-line mixing of the plurality of fluids to form a reactive resin composition, and (3) casting the reactive resin composition onto a release material to form a cast film.

Described first is (1) the step for preparing a plurality of fluids that are reactive with each other. The flexographic printing plate precursor for laser engraving according to the present invention has at least an engraving layer to be engraved, and the engraving layer is produced from a reactive resin composition.

In (1) the step for preparing a plurality of fluids that are reactive with each other, the components of a reactive resin composition are divided into a plurality of fluids, for example, a first fluid and a second fluid, and they are prepared separately. For instance, based on comparison in reactivity among the various components, the components of the reactive resin composition are divided as follows: first fluid components to be included in the first fluid, second fluid components to be included in the second fluid, . . . and n'th fluid components to be included in the n'th fluid (n is a positive integer of 3 or larger), as required. The rule of classification is that components reactive with each other are not included in the same fluid. In the case of (i) a reactive resin composition containing an ethylenically unsaturated monomer and a polymerization initiator, for instance, a first fluid containing the ethylenically unsaturated monomer and a second fluid containing the polymerization initiator are prepared separately. In the case of (ii) a reactive resin composition containing hydroxyl group-containing compound and a crosslinking agent reactive with the hydroxyl group, a first fluid containing the hydroxyl group-containing compound and a second fluid containing the crosslinking agent reactive with the hydroxyl group are prepared separately. If the reactive resin composition further contains other components such as polymer, laser absorbent, plasticizer, polymerization inhibitor, thermal stabilizer, surfactant, light absorbent, and solvent, they may be added to either fluid or added to both fluids as long as they virtually do not cause any reaction to proceed and do not depress production efficiency or production stability. Here, it is preferable that at least one of the fluids is a mixture of a plurality of liquid components or a mixture of liquid component(s) and solid component(s). It is more preferable that all fluids are mixtures of a plurality of liquid components or mixtures of liquid component(s) and solid component(s).

A fluid consisting only of liquid components can be prepared by weighing out the components, putting them in a container, and if necessary, stirring them. Useful stirring methods include, for instance, rotating stirrer blades in the container and rotating the entire container.

When a fluid containing solid components is prepared, it is preferable that the solid components are first dissolved or swollen and then mixed with the liquid components. For instance, when a solid polymer component is added, it is preferable that the polymer is first dissolved or swollen in a solvent or plasticizer and then mixed with other components. It is preferable that the mixing is performed under heated conditions in order to shorten the time required for the preliminary dissolution or swelling, reduce the volume of the solvent required for the dissolution, and shorten the time required for the volatilization of the solvent in the undermentioned steps (4) and (6). From the viewpoint of shortening the time required for dissolving solid components, it is preferable that the dissolution temperature of the solid components is 30° C. or more, more preferably 70° C. or more. On the other hand, from the viewpoint of depressing the utilities cost required for the dissolution, it is preferable that the temperature is 150° C. or less, more preferably 130° C. or less. When the dissolution of solid components is carried out at a higher temperature than the boiling point of the solvent, the dissolution is performed in an airtight pressure vessel and after the completion of dissolution, the temperature in the pressure vessel is lowered to below the boiling point of the solvent. From the viewpoint of prevention of powder explosion, it is preferable that the dissolution of solid components is performed in a nitrogen atmosphere.

Of the various components that constitute each fluid, reactive ethylenically unsaturated monomers, polymerization initiators, and crosslinking agents reactive with the hydroxyl group should preferably be added and mixed in the last stage of preparation.

The fluid prepared should be stored in storage containers (11 and 21) as required. It is preferable that the fluids prepared separately are stored for at least one hour to ensure noticeable effect of the present invention.

It is preferable that after adding a reactive ethylenically unsaturated monomer, polymerization initiator, or crosslinking agent reactive with the hydroxyl group, the fluid is stored at a temperature of 30° C. or more, more preferably 40° C. or more, from the viewpoint of utilities cost. On the other hand, it is preferable that the temperature is 90° C. or less from the viewpoint of preventing the progress of reaction in the fluid during storage.

It is preferable that for each of the plurality of fluids, that is, first fluid, second fluid, and if necessary, n'th fluid (n is a positive integer of 3 or larger), that constitute the reactive resin composition, the viscosity increase rate is 10% or less, more preferably 5% or less, in 24 hours at the storage temperature, from the viewpoint of production stability. If the viscosity increase rate is 10% or less, the formation of gel materials from each fluid can be depressed to allow continuous production to be performed stably for 24 hours. Furthermore, if two or more preparation lines are operated in parallel, continuous production will be able to be maintained for 24 hours or more. Each fluid may be stored in the airtight container used for its preparation or in another container, but it is preferable to use an airtight container because compositional changes of the fluid can be prevented. Such fluids for producing a reactive resin composition according to the present invention tend to have a high viscosity of, for instance, 5 Pa·s or more depending on the solvent content, and it is also preferable that pressure containers are used as the storage containers for the fluids since pressure may be applied for feeding of the fluids from the containers.

Even when preparing a reactive resin composition with high reactivity, storage stability of the fluids can be maintained easily by allocating highly reactive components to the second fluid and other components to the first fluid and storing them separately. In the case of a thermal polymerization type composition, for instance, an ethylenically unsaturated monomer and a thermal polymerization initiator are the components that are highly reactive with each other, and therefore, the storage stability of the first fluid can be improved dramatically by allocating only either of them to the second fluid. In the case of a reactive resin composition containing a hydroxyl group-containing compound and a crosslinking agent reactive with the hydroxyl group, the storage stability of fluid can be improved dramatically by allocating them to different fluids. If there are there or more components that are highly reactive with each other, a target storage stability can be ensured by allocating them to three or more fluids.

The number of fluids prepared separately for a reactive resin composition should be as small as possible, and two is the most preferable. This is because an increase in their number will lead to an increase in the number of pieces of equipment such as reaction containers (11 and 21), fluid feeding lines (12 and 22), and fluid conveyors (13 and 23) that are required for them.

After the preparation of the fluids, it is preferable that deaeration is carried out to remove bubbles from the fluids. Deaeration may be achieved by leaving the fluids to stand for a long period of time, but the fluids may have to be left to stand for an extended time if they are high in viscosity. It is preferable, therefore, to achieve deaeration by pressure reduction. If a fluid contains a solvent or volatile component, small parts of the solvent or volatile component may be lost by volatilization, and therefore, it may be appropriate to perform condensation slightly in addition to removing bubbles by pressure reduction. Controlling the condensation rate serves to obtain fluids suitable to form a reactive resin composition with a specific composition ratio.

Described next are (2) the step for carrying out in-line mixing of the plurality of fluids to form a reactive resin composition, and (3) the step for casting the reactive resin composition onto a release material to form a cast film. In step (2), the mutually reactive fluids (11 and 21) prepared in step (1) are subjected to in-line mixing using, for instance, an in-line mixer (31) to achieve immediate production of a reactive resin composition. Subsequently, in step (3), the reactive resin composition is cast through a coater (32) onto a release material (41) to form a cast film (42). It is preferable that step (2) is carried out immediately before step (3) because it can prevent thermal reaction from resulting from retention in the fluid feeding line extending from the mixing apparatus to the casting apparatus and prevent an increase in viscosity of the reactive resin composition from being caused by thermal reaction, thus ensuring stable production. The term “immediately before” as used here means that the retention time from mixing to casting is preferably 1 hour or less, more preferably 20 min or less, still more preferably 10 min or less.

From the viewpoint of temperature control, it is preferable that the fluids (11 and 21) to form a reactive resin composition are fed through temperature-controlled fluid feeding lines (12 and 22) that connect the storage containers (11 and 21) to the coater (32). The fluid feeding lines (12 and 22) are the pipes that serve to send the fluids from the containers (11 and 21) of the fluids to the coater (32) through the in-line mixer (31). Such fluid feeding lines (12 and 22) may be, for instance, double pipes or simple pipes equipped with ribbon heaters. It is preferable to use double pipes from the viewpoint of thermal efficiency and temperature stability. Circulation of a temperature-controlled heating medium such as warm water through the outer channel of each double pipe serves to maintain the fluid flowing through the inner channel and the reactive resin composition prepared by mixing at a constant temperature.

The in-line mixing mechanism uses a line mixer that is connected directly to the fluid feeding lines and works to mix the plurality of fluids uniformly. There are two types of line mixers, namely, static mixers and dynamic mixers.

A static mixer has mixing elements fixed in a pipe, and mixing energy is generated as a fluid passes through the mixer to generate a velocity energy to work as the driving force. It is advantageous in requiring only simple facilities because it is not necessary to drive the mixing elements. However, the mixing energy obtained is limited, and may fail to achieve sufficient mixing depending on the viscosity difference and mixing ratio between the fluids to be mixed. Furthermore, a pressure loss takes place when velocity energy is converted into mixing energy, and accordingly, the pressure in the fluid feeding lines can become high, requiring in some cases the fluid feeding lines and optional filters directly connected to the lines to have increased pressure resistance. Many useful static mixers varying in number of mix elements, shape, and diameter are commercially available from different manufacturers including Kenics, Etoflo, and Sulzer.

A dynamic mixer actively drives mixing elements provided in pipes, and mixing energy is created by the rotational and reciprocal motions of the mixing elements. This is advantageous because mixing energy is generated by the mix elements, adequate mixing performance is obtained and the mixing conditions such as rotating speed of the mix elements can be varied widely, leading to an increased selection of usable processes. It is also advantageous in that the pressure loss in the mixer is so small that the fluid feeding lines and filters are not required to be highly pressure resistant. Driving devices (motors etc.) to drive mixing elements are necessary, and accordingly, large scale equipment tends to be required. Such dynamic mixers include, for instance, rotary dynamic mixers and vibroenergy mixers.

An extruder such as single screw extruder and twin screw extruder can be used as a line mixer, but such an extruder may apply a large shear to the reactive resin composition as a result of axis rotation and release heat in many cases, requiring special measures such as shortening the axis length and cooling the extruders by means of a chiller.

A method serving for constant feeding of each fluid to the in-line mixer (31) at a predetermined flow rate is to (i) forcedly supply each fluid from the storage containers (11 and 21) to the fluid conveyors (13 and 23) and (ii) feed the fluid constantly to the in-line mixer (31) by the fluid conveyors (13 and 23).

Useful methods to (i) forcedly supply each fluid from the storage containers (11 and 21) to the fluid conveyors (13 and 23) include aspirating each fluid by, for instance, aspirators, installing the storage containers (11 and 21) for the fluids at a position higher than the fluid conveyors (13 and 23) to cause natural supply by the fluid's own weight, and compressing the storage containers (11 and 21) to cause the fluids to be fed by the pressure.

The (ii) fluid conveyors (13 and 23) may be, for instance, a Moineau pump, turbine pump, volute pump, multi-stage pump, axis flow pump, piston pump, plunger pump, diaphragm pump, gear pump, Nash pump, friction pump, acid egg, and squirted pump, of which an appropriate one is selected based on required fluid feeding rate, liquid viscosity, and internal pressure in pipes.

The cast film (42) will form an engraving layer after being heated in step (4), and accordingly, it is preferable that the cast film (42) has an accurately controlled thickness from the viewpoint of good film thickness control for the flexographic printing plate precursor. For this, it is preferable that the reactive resin composition is discharged through the coater (32) designed to allow the composition to be extended uniformly in the width direction. Such the coater (32) may be, for instance, a T-die, coat hanger die, fishtail die, or slit die coater. Of these, the coat hanger die and fishtail die have been particularly preferred as coater to discharge a reactive resin composition because they seldom suffer from abnormal retention inside.

To obtain a cast film (42) with a uniform accurate thickness in the flow direction, furthermore, it is preferable that the release material (41) is conveyed at a constant speed by speed controlled conveyance equipment such as, for instance, a conveyor belt (33). Alternatively, the position of the release material (41) may be fixed while the coater (32) is moved above and along the release material at a constant speed.

The release material (41) as referred to herein is a carrier that serves in such a manner that it does not maintain strong contact with the cast film (42) so that the cast film (42) can be peeled off at a moment when the solvent in the cast film (42) has evaporated at least partly or crosslinking reaction has proceeded partly in the cast film (42), after heating of the cast film (42) along with the release material (41) by means of a heating device (51). Specifically, it is preferable that the peel force required for the cast film (42) and the release material (41) is 2 mN/cm to 250 mN/cm, more preferably 2 mN/cm to 100 mN/cm. A peel force of 2 mN/cm or more prevents the cast film (42) from being peeled off during heating, and a peel force of 250 mN/cm or less allows the cast film (42) to be peeled off easily.

The release material (41) may be, for instance, silicone resin, fluorine resin, PET film, or PP film. The release material (41) may be in the form of a body with its surface covered with a substance as listed above and, for instance, it may be a stainless steel plate coated with silicone resin. Furthermore, the release material may be either integrated with the conveyor belt (33) or simply placed on the conveyor belt (33).

Next, (4) the step for heating the cast film, and (5) the step for peeling off the cast film from the release material to form an independent sheet of the reactive resin composition are described below with reference to FIG. 2. The cast film (42) is heated in step (4) according to the present invention and it is peeled off from the release material (41) in step (5) to provide an independent sheet (43). An independent sheet (43) as referred to herein is a sheet-like material made only of a reactive resin composition and preferably has a sheet strength at 25° C. of 6 N/cm or more, more preferably 10 N/cm or more. A sheet strength of 6 N/cm or more ensures that the independent sheet can be peeled off without being suffering from sheet breakage. A specimen for sheet strength test is prepared by punching a sheet using a dumbbell as specified in Item 3 of JIS K-6251 (2004) to produce a piece with a measuring width of 5.0 mm. The top of a spring balance is firmly fixed, and a test specimen is put to its lower end. The test specimen is pulled down at a rate of about 2 to 4 cm/sec, and the weight A (in grams) at the moment of rupture of the sheet is determined. Five runs are performed and their average Ax (in grams) is used to calculate the sheet strength P (N/cm) by the following equation: P=9.8×Ax/(1,000×0.5).

Useful methods for peeling off the release material (41) from the cast film (42) include, for instance, heating the cast film (42) to volatilize at least part of the solvent in the cast film (42) and causing the crosslinking reaction of the cast film (42) to progress at least partly. If the polymer existing in the reactive resin composition is one that can maintain its shape by itself as in the case of, for instance, partially saponified polyvinyl alcohol, an independent sheet (43) with a targeted sheet strength can be obtained by volatilizing the solvent in the cast film (42). If the polymer in the reactive resin composition is not one that cannot maintain its shape by itself as in the case of, for instance, polyvinyl butyral, an independent sheet (43) cannot be obtained by simply volatilizing the solvent in many cases, whereas an independent sheet (43) can be obtained by promoting the crosslinking reaction of the reactive resin composition.

When heating the release material (41) in combination with the cast film (42), volatilization of the solvent and/or crosslinking reaction proceed to a larger extent as the heating time increases, serving for easy enhancement of the sheet strength and formation of an independent sheet. However, effective heating can be performed only for the face opposite to that provided with the release material (41), and the solvent volatilization efficiency and/or crosslinking reaction rate are low. Therefore, it is preferable that the drying before the peeling step is carried out only to such an extent that a required sheet strength is achieved. It is preferable that the heating temperature for this purpose is lower than the boiling point of the solvent under atmospheric pressure. This is because formation of bubbles in the sheet is easily caused by bumping of the solvent if drying is performed at or above the boiling point.

It is preferable that step (5) is further followed by (6) a step for heating the independent sheet of the reactive resin composition in order to volatilize the solvent from the independent sheet and/or promoting the crosslinking reaction of the independent sheet. Both faces of the independent sheet (43) are exposed and the two faces can be heated simultaneously. Simultaneous heating of both faces serves for efficient production of a thick film with a dry film thickness of 0.4 mm to 6 mm as required for flexographic printing plate precursors. It is preferable that the heating temperature for this purpose is also lower than the boiling point of the solvent under atmospheric pressure as in the case of step (4).

Furthermore, (7) a step for combining the independent sheet of the reactive resin composition with a support layer may be further included as required. As shown in FIG. 3, the independent sheet (43) produced in step (5) and, if necessary, step (6) and the support (44) are combined together to produce a layered product (45) consisting of the independent sheet and the support. The independent sheet will form an engraving layer. Combining an independent sheet and a support serves to impart dimensional stability to the flexographic printing plate precursor for laser engraving and impart moderate nerve to a flexible engraving layer to improve its handleability.

The combining of the independent sheet (43) and the support (44) can be achieved by, for instance, direct pressure-bonding of the independent sheet (43) and the support (44), or pressure-bonding of them after wetting the independent sheet with a solvent, or a chemical that can swell the independent sheet, or a monomer with affinity with the independent sheet. Useful methods for pressure-bonding include, for instance, pressing by a pressing machine and nipping between calendering rolls (61 and 62), and pressure-bonding may be performed under heated conditions maintained by, for instance, heating the pressing machine or rolls at an appropriate temperature, e.g., 100° C.

There are no specific limitations on the material of the support to be used for the present invention, but it is preferable that it is dimensionally stable, and preferable materials include, for instance, metals such as steel, stainless steel, and aluminum; plastic resins such as polyester (e.g., PET, PBT, and PAN) and polyvinyl chloride; synthetic rubbers such as styrene-butadiene rubber; and plastic resins (e.g., epoxy resin and phenol resin) reinforced with glass fiber. In particular, PET (polyethylene terephthalate) films and steel substrates have been preferred. The thickness of the support is preferably 50 μm to 350 μm, more preferably 75 μm to 250 μm.

In many cases, the engraving layer and the support are not adhesive to each other and therefore, an adhesion layer may be provided to increase the bonding strength between the layers. It is preferable that the material used to constitute the adhesion layer has affinity with both the engraving layer and the support. In the case where the engraving layer contains partially saponified polyvinyl alcohol and the support is a polyester film, for instance, the engraving layer and the support can be bonded strongly by providing an adhesion layer containing partially saponified polyvinyl alcohol and polyester resin. It is preferable that the material used in the adhesion layer is the same polymer or polymer of the same type as the engraving layer and the support. A polymer of the same type as referred to here is a chemical compound that has the same main backbone but differs in molecular weight, purity, and number of functional groups. Specifically, in the case where the engraving layer contains a partially saponified polyvinyl alcohol with a polymerization degree of 500 and an average saponification degree of 82%, the adhesion layer may contain a partially saponified polyvinyl alcohol of the same specification, may contain a partially saponified polyvinyl alcohol in which part of the hydroxyl groups are modified with carboxylic acid, or may contain a partially saponified polyvinyl alcohol with a different saponification degree, e.g., with a saponification degree of 70%.

The adhesion layer may be a single layer or may be a multi-tiered layer consisting of two or more tiers. The material of the engraving layer and the support have polarities, as represented by, for instance, solubility parameters (SP values), close to each other, the materials can mix easily to form a single tier adhesion layer, but if they largely differ in polarity in such a manner that, for instance, one is a partially saponified polyvinyl alcohol (SP value 12.6) while the other is polyester resin (SP value 10.7), their mutual compatibility will be poor and it will be difficult to mix them. In such a case, the compatibility can be improved by adding a material with an intermediate polarity (such as phenol resin) as a compatibilizer or using a two tier adhesion layer. Required adhesion can be achieved in the case where the second adhesion layer, which faces the engraving layer, contains a partially saponified polyvinyl alcohol, i.e., the same material as the engraving layer, while the first adhesion layer, which faces the support contains the same type of polyester resin as the support, and at least either the first adhesion layer or the second adhesion layer contains a material that can bond them to each other. Such a material that bonds the two tiers may be a material with an intermediate polarity as described above or a material that undergoes a chemical reaction such as polymerization of monomers and condensation of an isocyanate and a hydroxyl group.

The bond strength referred to here means either the strength of the bond between the support and the adhesion layer or that between the adhesion layer and the engraving layer. It is preferable that the bond strength between the support and the adhesion layer is such that when the adhesion layer and the engraving layer are peeled off from a tiered body consisting of a support, adhesion layer, and engraving layer at a speed of 400 mm/min, the peel force per cm width of the specimen is 1.0 N/cm or more or peeling is impossible. More preferably, it is 3.0 N/cm or more, or peeling is impossible. It is preferable that the bond strength between the adhesion layer and the engraving layer is such that when the adhesion layer is peeled off from a tiered body consisting of the adhesion layer and engraving layer at a speed of 400 mm/min, the peel force per cm width of the specimen is 1.0 N/cm or more or peeling is impossible. More preferably, it is 3.0 N/cm or more, or peeling is impossible. In the case where no adhesion layer is provided, it is preferable that when the engraving layer is peeled off from a tiered body consisting of the support and engraving layer at a speed of 400 mm/min, the peel force per cm width of the specimen is 1.0 N/cm or more, or peeling is impossible. More preferably, it is 3.0 N/cm or more, or peeling is impossible.

Furthermore, (8) a step for combining an independent sheet (43) and a temporary support layer as shown in FIG. 4 may be further included. Adding a temporary the support (46) serves to prevent flaws and dents from being caused on the surface of the engraving layer and impart moderate nerve to the flexible engraving layer to improve its handleability. This is favorable because the engraving layer is where reliefs are to be cut by laser engraving and the top surface of the reliefs are to function for carrying ink.

It is preferable that the thickness of the temporary support (46) is 25 μm or more, more preferably 50 μm or more, from the viewpoint of preventing flaws and dents. From the viewpoint of cost, on the other hand, it is preferable that the thickness is 500 μm or less, more preferably 200 μm or less.

The temporary support (46) may be made of a generally known material for printing plate protection film, for instance, polyester based films such as PET (polyethylene terephthalate) and polyolefin based films such as PE (polyethylene) and PP (polypropylene). Such films may have a plain surface or a matted surface.

If a temporary support is provided on the independent sheet, that is, the engraving layer, the temporary support should be removable. If the temporary support is unremovable or difficult to remove, or if on the contrary, it can be removed too easily because of weak bonding between the engraving layer and the temporary support, a slip coat layer may be provided between these layers. The slip coat layer may be, for instance, a layer containing the same polymer or a polymer of the same type as the one contained in the reactive resin composition, which will ensure good bonding to the engraving layer formed of the reactive resin composition. It is preferable that the content of the polymer that exists in the layer containing the same polymer or a polymer of the same type as the one contained in the reactive resin composition is 70 wt % layer or more, more preferably 90 wt % or more. If the polymer content is 70 wt % or more, the contents of low molecular adhesive components such as, for instance, ethylenically unsaturated monomers will be relatively low, and accordingly, the strength of the bond to the temporary support will decrease, ensuring easy removal of the temporary support.

It is preferable that when the temporary support is peeled off from a tiered body consisting of the engraving layer (and a layer containing the same polymer or a polymer of the same type as the one contained in the reactive resin composition) and the temporary support at a speed of 200 mm/min, the peel force per cm width is 5 to 200 mN/cm, more preferably 10 to 150 mN/cm. Removal of the temporary support will not take place during operations if it is 5 mN/cm or more, while the temporary support can be peeled off smoothly if it is 200 mN/cm or less. The layer containing the same polymer or a polymer of the same type as the one contained in the reactive resin composition may remain in the engraving layer after peeling off the temporary support, or may be removed along with the temporary support.

Useful methods for the laminate formation in step (8) include, for instance, the process of pressure-bonding the temporary support (46) and the independent sheet (43) using, for instance, heated calender rolls (63 and 64), the process of impregnating the surface of the independent sheet (43) with a small amount of a solvent, followed by bringing it into close contact with the temporary support (46), and the process of injecting a reactive resin composition (47) of the same make-up as or a similar make-up to the independent sheet (43) between the independent sheet (43) and the temporary support (46) so that it is sandwiched in between. The latter process, in particular, has been preferred because a uniform thickness of the layered structure is achieved by allowing it pass between calendering rolls (63 and 64) having a uniformly controlled clearance. Here, the calendering rolls (63 and 64) may be heated if required. In the latter process, the independent sheet (43) and the reactive resin composition (47) of the same make-up as or a similar make-up to the independent sheet will form an engraving layer over time. In the other cases, the independent sheet (43) alone forms an engraving layer.

If both step (7) and step (8) are performed for the present invention, the order of operation of step (7) and step (8) is arbitrary.

In addition, (9) a step for crosslinking the engraving layer may be further included. If the engraving layer contains a photopolymerization initiator, photocrosslinking of the engraving layer can be achieved by applying active ray such as ultraviolet light through the temporary support, or after removing the temporary support, or through the support. If the engraving layer contains a thermal polymerization initiator, thermal crosslinking of the engraving layer can be achieved by heating it. Useful heating methods include, for instance, leaving the precursor to stand in a hot air oven or far-infrared oven for a required time and maintaining it in contact with a heated roll for a required time.

### EXAMPLES

The invention is described in more detail below with reference to Examples.

<Preparation of Support 1 Coated with Adhesion Layers>

A mixture of 260 parts by weight of Vylon (registered trademark) 300 (toluene solution of unsaturated polyester resin, supplied by Toyobo Co., Ltd.) and 2 parts by weight of PS-8A (benzoin ethyl ether, supplied by Wako Pure Chemical Industries, Ltd.) was heated at 70° C. for 2 hours and then cooled to 30° C., and 7 parts by weight of an ethylene glycol diglycidyl ether dimethacrylate was added, followed by mixing them for 2 hours. Furthermore, 25 parts by weight of Coronate (registered trademark) 3015E (ethyl acetate solution of multi-functional isocyanate resin, supplied by Nippon Polyurethane Industry Co., Ltd.) and 14 parts by weight of EC-1368 (industrial adhesive, supplied by Sumitomo 3M Limited) were add to provide a coating liquid composition for the first adhesion layer.

Then, 10 parts by weight of ε-caprolactam, 90 parts by weight of a nylon salt of N-(2-aminoethyl) piperazine and adipic acid, and 100 parts by weight of water were put in a stainless steel autoclave, and heated at 180° C. 1 hour after replacing the internal air with nitrogen gas, followed by removing water to provide a hydrophilic polyamide resin with a relative viscosity (viscosity of a solution of 1 g of polymer dissolved in 100 ml of chloral hydrate, measured at 25° C.) of 2.50.

Then, 48 parts by weight of Denka Butyral #3000-2 (polyvinyl butyral, supplied by Denki Kagaku Kogyo Kabushiki Kaisha) and 5 parts by weight of the hydrophilic polyamide resin obtained above were dissolved in 400 parts by weight of Solmix (registered trademark) H-11 (alcohol mixture, supplied by Japan Alcohol Trading Co., Ltd.) at 70° C. for 2 hours, and 1.5 parts by weight of Blemmer (registered trademark) G (glycidyl methacrylate, supplied by NOF Corporation) was added and mixed for 1 hour. Subsequently 5 parts by weight of Irgacure (registered trademark) 651 (benzyl dimethyl ketal, supplied by Ciba-Geigy), 21 parts by weight of Epoxy Ester 70PA (acrylic acid adduct propylene glycol diglycidyl ether, supplied by Kyoeisha Chemical Co., Ltd.), and 20 parts by weight of ethylene glycol diglycidyl ether dimethacrylate were added and mixed for 90 min, and after cooling to 50° C., 0.1 part by weight of Megaface (registered trademark) F-470 (perfluoroalkyl group-containing oligomer, supplied by DIC Corporation) was added and mixed for 30 min to provide a coating liquid composition for the second adhesion layer.

The coating liquid composition for the first adhesion layer was spread with a bar coater over a 188 μm-thick sheet of Lumirror (registered trademark) #188T60 (polyester film, supplied by Toray Industries, Inc.) used as the support in such a manner as to ensure a dry film thickness of 30 μm, and left in an oven at 180° C. for 3 min to remove the solvent. On top of it, the coating liquid composition for the second adhesion layer was spread with a bar coater in such a manner as to ensure a dry film thickness of 18 μm, and left in an oven at 160° C. for 3 min to provide support 1 coated with adhesion layers, which was intended to produce a layered structure consisting of the second adhesion layer, first adhesion layer, and support.

The first adhesion layer, which contains polyester resin as the main component, has a similar make-up to the polyester film used as the support and therefore, can develop a strong bond to the support. The second adhesion layer contains polyvinyl butyral as the main component and accordingly, can develop a strong bond to the engraving layer that contains polyvinyl butyral as the main component, as in the above case. Both the first adhesion layer and the second adhesion layer contain (meth)acrylate monomers and accordingly, can develop a strong bond to each other.

### Example 1

### (Preparation of Carbon Black Dispersion Liquid 1)

First, 10 parts by weight of S-LEC (registered trademark) BL-1 (polyvinyl butyral, supplied by Sekisui Chemical Co., Ltd.) was added to 60 parts by weight of ethanol and heated at 70° C. for 2 hours to ensure dissolution, followed by cooling to 25° C. to provide a polymer solution. To the resulting polymer solution, 15 parts by weight of MA100 (carbon black, supplied by Mitsubishi Chemical Corporation) was added and stirred with a homogenizer at 15,000 rpm for 30 min to provide a preliminary carbon black dispersion liquid. Subsequently, a triple roll mill was used to carry out kneading and dispersion. Furthermore, 10 parts by weight of ethanol was added to this dispersion liquid and stirred for 30 min, and additional ethanol was added so as to ensure a solid content of 25 wt %, thus providing carbon black dispersion liquid 1.

### <(1-1) Preparation of First Fluid>

A small-scale pressure vessel with a capacity of 25 L was used to prepare the first fluid to be used to produce a reactive resin composition for the engraving layer. This container is resistant to a pressure of 0.5 MPa, made of SUS304, and provided with, as stirring blade, a double helical ribbon with a blade diameter of 0.32 m, and its stirring speed can be varied in the range of 0 to 200 rpm. The top portion of the pressure vessel is provided with a pressure gauge, vent valve, nitrogen valve, pressure reducing valve (all valves have cocks), and inspection window, and a bell jar is provided at the material feed port. The bottom portion of the pressure vessel is provided with a bottom cock valve for extracting the reactive resin composition and a thermocouple for measuring the inner temperature. The reaction container has a double structure, and the outer tank and the inner tank are used for temperature control by a heating medium and preparation of the reactive resin composition, respectively. The piping is designed so that steam (maximum setting 150° C.), warm water (maximum setting 95° C.), and cooling water of 15° C. can be used as heating medium.

The vent valve of the small-scale pressure vessel was opened, and 1.77 g of 4-hydroxy-2,2,6,6-tetramethyl piperidinyl-1-oxyl free radical (supplied by Tokyo Chemical Industry Co., Ltd.) as polymerization inhibitor, 5.74 kg of propylene glycol monomethyl ether monoacetate (supplied by Daicel Chemical Industries, Ltd.) as solvent, and 1.062 kg of DCHP (dicyclohexyl phthalate, supplied by Osaka Organic Chemical Industry Ltd. industry) as plasticizer were added through the material feed port, followed by activating the stirrer blade to rotate at 150 rpm, followed by adding 3.92 kg of Denka Butyral #3000-2 (polyvinyl butyral, supplied by Denki Kagaku Kogyo Kabushiki Kaisha). At this point, the liquid temperature was 25° C.

Subsequently, the bell jar was fixed to the material feed port with bolts and nuts and the vent valve was closed to hermetically seal the pressure vessel. To prevent powder explosion, the nitrogen valve was opened to achieve compression at 0.25 MPa (inner pressure in container at this point 0.35 MPa), and then the vent valve was opened to restore atmospheric pressure (inner pressure in container at this point 0.10 MPa), followed by repeating compression at 0.25 MPa by nitrogen and opening of the vent valve until the reaction container was filled with nitrogen. After filling the reaction container with nitrogen, the vent valve was closed again to hermetically seal it. The rotation of the stirring blade at 150 rpm was continued during this operation.

The warm water valve leading to a 80° C. warm water tank was opened, and a warm water pump was activated to allow warm water to circulate through the outer tank of the reaction container to heat it until the liquid temperature in the reaction container reached 70° C. When a temperature of 70° C. was reached, the temperature setting of the warm water tank was changed to 75° C., and in this state, the stirring blade was continued to rotate at 150 rpm for 120 min to ensure dissolution of the polymer. At this point, the inner temperature of the reaction container was 75° C., and the inner pressure was 0.13 MPa.

After opening the vent valve to return the container's inner pressure to atmospheric pressure (0.10 MPa), the bell jar was removed from the material feed port, and as ethylenically unsaturated monomers, 1.59 kg of Blemmer LMA (lauryl methacrylate, supplied by NOF Corporation) and 0.885 kg of Aronix (registered trademark) M-400 (dipentaerythritol penta/hexa-acrylate, supplied by Toagosei Co., Ltd.) were added from the material feed port. Furthermore, 0.690 kg of 18% Octope Zn (zinc 2-ethyl hexanoate, supplied by Hope Chemical Co. Ltd.) was added as sensitization agent to increase the sensitivity to laser engraving, and 0.442 kg of carbon black dispersion liquid 1 was added as infrared laser absorbent.

Following this, the bell jar was fixed to the material feed port with bolts and nuts, and the vent valve was closed to hermetically seal the pressure vessel again. In this state, stirring was continued for 30 min to complete the preparation of the first fluid. At this point, the inner temperature of the reaction container was 75° C., and the inner pressure was 0.10 MPa.

Subsequently, the rotating speed of the stirring blade was adjusted to 40 rpm, and the pressure reducing valve was opened to ensure reduced-pressure deaeration and condensation. The pressure reducing valve is connected to an aspirator via a condensation-cooling pipe and a condensate collecting pipe. The condensation-cooling pipe is a double pipe and serves to circulate 15° C. cooling water through the outer tube.

When reducing the pressure, the pressure reducing valve was opened gradually, and the degree of vacuum was adjusted so that the level of the first fluid would not rise to the upper wall level of the reaction container. When the inner pressure of the pressure vessel reached 0.02 MPa, deaeration had finished almost completely, and the first fluid started to boil. The rotation of the stirring blade was stopped to prevent trapping of bubbles due to stirring. The vapor of the solvent cooled by the condensation-cooling pipe was accumulated in the condensate collecting pipe. Condensation was continued until distillation of 320 mL was achieved, followed by closing the pressure reducing valve and stopping the aspirator. At this point, the inner pressure of the pressure vessel was 0.005 MPa, and the liquid temperature of the first fluid had fallen to 68° C. as a result of removal of heat of evaporation. The liquid distilled out was recovered, and according to measurements made, its weight was 260 g.

Following this, the vent valve was opened to return the inner pressure to atmospheric pressure (0.10 MPa), and nitrogen was supplied for compression up to 0.40 MPa. Subsequently, the temperature of the warm water used as the heating medium for the pressure vessel was changed from 75° C. to 70° C., and the first fluid was stored under this condition.

### <Evaluation of Thermal Stability of First Fluid>

The viscosity was measured immediately after the completion of condensation (within 1 hour) and after storage for 24 hours, and the thermal stability of the first fluid was evaluated based on the change in viscosity. To prepare liquid samples for evaluation, the bottom cock valve located in the bottom portion of the reaction container was opened, and about 50 g of the liquid was sampled after discarding about 500 g of liquid which may have been retained in the piping.

A Rheomat 115 viscometer (supplied by Contraves) was used for viscosity measurement, and the liquid for evaluation was poured in the inner tube with an inner size (diameter) of 30.5 mm and stored at 70° C. in a temperature controlled bath provided with an automatic temperature control device (supplied by Julabo). A No. 3 rotor with a rotor size (diameter) of 12 mm was used, and measurements were made at a rotor rotating speed of 130 rpm. To make measurements, a liquid specimen for evaluation was injected, and the rotor was activated at 21.6 rpm for 30 min to stabilize the liquid temperature. Then the rotor's rotating speed was adjusted to 130 rpm, and measurements were made in 1 min, followed by viscosity calculation. The viscosity was 10.0 Pa·s after 30 min following condensation, and the viscosity was 9.8 Pa·s after storage for 24 hours. There was no rise in viscosity, indicating that thermal stability was high.

### <(1-2) Preparation of Second Fluid>

Three kg of Perbutyl (registered trademark) Z (t-butylperoxy benzoate, supplied by NOF Corporation) as thermal polymerization initiator and 6 kg of propylene glycol monomethyl ether monoacetate (supplied by Daicel Chemical Industries, Ltd.) were put in a petroleum can with the inner wall coated with polyethylene film, and mixed by rotating the tightly stopped petroleum can repeatedly for 30 min by “Mazemaze Man” (registered trademark) SKH-30 (supplied by Misugi Co., Ltd.) to prepare the second fluid. The second fluid was put in a SUS304 container (capacity 20 L) placed in a room controlled at 20° C. to 30° C., and nitrogen was supplied for compression to 0.20 MPa. The liquid was stored at room temperature.

### <Evaluation of Thermal Stability of Second Fluid>

The viscosity was measured immediately after the completion of mixing (within 1 hour) and after storage for 24 hours, and the thermal stability of the second fluid was evaluated based on the change in viscosity. Brookfield type viscometer (model BL, supplied by Tokyo Keiki Inc.) was used for viscosity measurement, and a liquid specimen for evaluation was maintained at 25° C. For the measurement, a No. 1 rotor was used at a rotor rotating speed of 60 rpm.

The viscosity was 3.0 mPa·s both after 30 min following mixing and after storage for 24 hours. There were no changes in viscosity, indicating that thermal stability was high.

<(2) Step for Carrying Out In-Line Mixing of the First Fluid and the Second Fluid to Form a Reactive Resin Composition, and (3) Step for Casting the Reactive Resin Composition onto a Release Material to Form a Cast Film>

### <Preparation of Release Material 1>

Here, 4.9 parts by weight of tetra(n-propoxy) silane and 0.1 part by weight of tetra(n-butoxy) titanium were dissolved in 45 parts by weight of toluene and 50 parts by weight of xylene to prepare a solution for primer layer formation. A SUS304 plate with a thickness of 1 mm, width of 55 cm, and length of 65 cm was cleaned with acetone, and the above solution for primer layer formation was spread over this SUS plate so as to ensure a dry film thickness of 0.5 μm, and dried at 30° C. for 2 hours.

Following this, PRX306 Dispersion Clear (silicone rubber solution for mold releasing agent, supplied by Dow Corning Toray Co., Ltd.) was spread over the primer layer formed above so as to ensure a dry film thickness of 50 μm and dried at 30° C. for 2 hours, then at 80° C. for 2 hours, and further at 100° C. for 4 hours to prepare release material 1. Release material 1 has a three layer structure consisting of SUS304, primer layer, and silicone rubber layer, of which the silicone rubber layer acts as release material.

### <Preparation of Release Material 2>

A sheet with a width of 50 cm Lumirror #100S10 (PET film with a center thickness of 100 μm, supplied by Toray Industries, Inc.) was attached to the silicone rubber layer of release material 1 prepared by the above process to prepare release material 2. Release material 2 has a four layer structure consisting of SUS304, primer layer, silicone rubber layer, and PET film, of which the PET film acts as release material. Combining release material 1 and PET film was achieved by causing them to pass between nip rolls (made of silicone rubber) adjusted to a nip pressure of 0.5 MPa while applying a tension of 30 N per 50 cm width of PET film, and a layered structure was obtained without suffering from lifting of the PET film or formation of creases.

<Discharge of Reactive Resin Composition through Coater>

A coat hanger die with a discharge width of 45 cm was used as coater for discharging a reactive resin composition. The discharge port was directed vertically downward, and the clearance (lip gap) of the discharge port was adjusted to a total width of 400 μm±20 μm. The injection port for the reactive resin composition was provided in the top portion of the coat hanger die, and connected to the fluid feeding line by a flexible hose. The fluid feeding system from the storage container of the first fluid for reactive resin composition formation to the coat hanger die consists of the bottom cock valve of the pressure vessel, fluid feeding line, gear pump for feeding the solution, fluid feeding line, filter unit, fluid feeding line, static mixer (T8-21R, equipped with 21 mixing elements in pipe with an inside diameter of 11.0 mm and length of 360 mm, supplied by Noritake Co., Limited), flexible hose, and injection port of the coat hanger die, which are connected in series. To monitor the pressure on the upstream side of the filter and that on the downstream side of the filter, a pressure gauge was provided at the inlet and the outlet of the filter unit. The second fluid was injected to the fluid feeding line immediately before the static mixer, and an injection valve for preventing back-flow was provided.

The fluid feeding line, filter unit, flexible hose, and coat hanger die have structures that can serve to pass a heating medium identical to that for keeping the first fluid at constant temperature, which is 70° C. warm water in this case, so that they can be maintained at the same temperature as its storage temperature. The fluid feeding line and flexible hose have a double pipe structure in which the heating medium and the first fluid pass through the outer tube and the inner tube, respectively. The filter house of the filter unit has a similar structure. The filter unit has a bleed port for bleeding out the first fluid, air valve for venting air, filter element, and filter house holding the filter element, and the filter element used was a pole filter made of epoxy cellulose (supplied by Pall Corporation) with a filtration limit of 50 μm. The gear pump used had a fluid feeding capacity of 7.2 cc per rotation, and the side clearance of the gear pump was adjusted to 20 μm to 25 μm to prevent thermal reaction from being caused by shearing force developed in the gear pump. The rotating speed of the gear pump can be varied in the range of 0 to 55 rpm, and the pump was driven by an explosion-proof motor. The storage container of the first fluid was constantly pressured at 0.4 MPa by nitrogen in order to achieve forced feeding of the first fluid to the inlet of the gear pump. The static mixer portion does not have a double pipe structure, and therefore, it was wrapped with insulating material to ensure heat insulation.

The fluid feeding system from the storage container of the second fluid used to form a reactive resin composition to the injection valve provided immediately before the static mixer consisted of a storage container, fluid feeding line, Moineau pump (fluid feeding rate variable from 4 cc/min to 50 cc/min, supplied by Heishin Ltd.), fluid feeding line, and injection valve, which were connected in series, and a 200 mesh strainer was provided in the fluid feeding line before the Moineau pump to serve as a foreign object filter for the second fluid. The fluid feeding path was not specially heat-regulated, and maintained at room temperature (20° C. to 30° C.).

A belt conveyor was provided under the coat hanger die, and release material 2 was put on the speed-controlled belt conveyor. A reactive resin composition produced by mixing the first fluid and the second fluid in the static mixer was discharged from the coat hanger die and cast onto release material 2. The rotating speed of the pumps were adjusted so that the gear pump would feed the first fluid at a fluid feeding rate of 283 g/min while the Moineau pump would feed the second fluid at a fluid feeding rate of 8.7 g/min. The line speed of the belt conveyor was set to 40 cm/min, and a cast film with a thickness of 1,700 μm was discharged onto the release material from the coat hanger die with a discharge width of 45 cm. The resulting cast film had a solvent content of 41 wt %.

<(4) Step for Heating the Cast Film, and (5) Step for Peeling Off the Cast Film from the Release Material to Form an Independent Sheet>

Release material 2 carrying a cast film formed in step (3) was heated under two sets of conditions, namely, conditions 1 and conditions 2. Under conditions 1, the cast film was heated in a hot air oven at 70° C. for 180 min, and then cooled for 30 min in a room adjusted to a temperature of 20° C. and relative humidity of 65%, followed by peeling off the cast film from release material 2. Under conditions 2, the cast film was heated in a hot air oven at 100° C. for 60 min, and then cooled in a room adjusted to a temperature of 20° C. and relative humidity of 65%, followed by peeling off the cast film from release material 2.

The sheet strength of the resulting sheet was measured to evaluate whether it would serve as an independent sheet, that is, whether the removed sheet would be free of breakage during handling.

A test specimen was prepared by fixing the above sheet to a vice and pressing it strongly with a dumbbell as specified in Item 3 of JIS K-6251 (2004) to punch a piece with a measuring width of 5.0 mm. At this time, the thickness of the portion of each sheet sample having a measuring width of 5.0 mm was measured, and it was found that the samples under conditions 1 and conditions 2 had a thickness of 1,060 μm and 1,100 μm, respectively.

A spring balance supplied by Sanko Co., Ltd. (maximum 1 kg, minimum scale 10 g) was prepared, and the top of a spring balance was firmly fixed while the test specimen was put to the hook at the bottom portion using Rivic Tape No. 401 (supplied by Nitto Denko Corporation). The test specimen was pulled down at a rate of about 2 to 4 cm/sec, and the load at the time of the sheet breaking was measured. Five measurements were made, and their average was calculated to provide the value of sheet strength. The sheet prepared under conditions 1 had a significantly low strength of less than 0.1 N/cm and was not likely to serve as independent sheet while the sheet prepared under conditions 2 had a high strength of 14 N/cm, indicating that an independent sheet was produced successfully. Cast films prepared under conditions 1 and conditions 2 were dried at 100° C. for 5 hours, and changes in their weight were measured and found to be about 10 wt % to 13 wt % for both films. The residual solvent content was nearly the same for both cast films, showing that the dominant factor in the independent sheet formation was the progress of crosslinking reaction in the reactive resin composition rather than the solvent volatilization out of the reactive resin composition.

<(6) Step for Volatilizing Solvent from Independent Sheet>

The resulting sheets were hung in a hot air oven controlled at 80° C., and two-side drying of the sheet was performed for 180 min. The sheet prepared under conditions 1 was ruptured under its own weight, whereas the sheet prepared under conditions 2, which was an independent sheet, was found to go through the subsequent steps successfully without suffering from rupture under its own weight. The thickness of the sheet prepared under conditions 2 was measured and found to be 740 μm to 880 μm, indicating a thickness range of 140 μm.

For evaluation regarding the residual solvent content in a sheet obtained from step (5) and a sheet heated additionally in step (6), a 5 cm×5 cm specimen was taken from each sheet and heated additionally for 3 hours, and the residual solvent content was determined from the difference in weight measured before and after the heating. Results showed that the residual solvent content in the sheet from step (5) was 11 wt % while the residual solvent content in the sheet from step (6) was less than 1.0 wt %, showing that the two-side drying in step (6) was effective in promoting solvent volatilization.

<(7) Step for Combining a Sheet with a Support Coated with Adhesion Layers>

Using a nip type laminator able to nip two rolls, the independent sheet prepared in step (6) under conditions 2 was combined with support 1 coated with adhesion layers to form a layered structure. The upper roll of the nip type laminator is a rubber roll, which can be moved up and down by air pressure to give or release a nip. The lower roll is a heatable metal roll, and it was heated at 110° C. The lower roll is also a driving roll. If the clearance between the upper and lower rolls was set in a push-in state, nipping operation causes the nipped material to move automatically. In this Example, the clearance between the upper and lower rolls was set to about 800 μm. The total thickness of support 1 coated with an adhesion layer was about 240 μm, and the average thickness of the sheet prepared in step (6) was 810 μm. The total thickness was about 1,050 μm, and accordingly, the push-in thickness resulting from the nipping operation was about 250 μm.

Support 1 coated with adhesion layers has its support surface in contact with the lower roll as it is supplied along the lower roll. Blemmer PME-200 (methoxy polyethyleneglycol monomethacrylate, supplied by NOF Corporation) was applied over one side of the independent sheet, which was supplied in such a manner that the coated surface faced the lower roll serving to supply the support. First, in a state where nipping was released, an ethylene glycol-coated surface at the end of a sheet was attached temporarily to the adhesion layer surface on the lower roll, and the temporary attachment surface was set between the nip rolls, followed by starting the nipping motion. The nipping pressure gives a driving force to the lower roll to cause automatic feeding of the nipped material. In the resulting nipped body, the independent sheet and the support were bonded strongly, and it was difficult to remove the independent sheet from the support.

<(8) Step for Combining a Sheet with a Temporary Support>

The combining of a sheet and a temporary support was performed by using a calender laminator provided with two metal rolls, and a front conveyor for supplying sheets at a constant speed (1.0 m/min in this Example) and a rear conveyor for conveying the laminate product at a constant speed (1.0 m/min in this Example) were provided before and after the laminator. The upper roll of the laminator can be heated (at 82° C. in this Example), and the lower roll can be moved up and down by air pressure. Since the clearance between the metal rolls determines the product thickness, both the upper and lower metal rolls should have a high degree of circularity, and the clearance along the width of the roll should be adjusted precisely. The metal rolls used in this Example have a radius of 12 mm, and the radius has an accuracy of 10 μm. The clearance between the upper and the lower roll was adjusted to 1,360 μm±5 μm.

A sheet of Lumirror #100S10 (polyester film, supplied by Toray Industries, Inc.) with a thickness 100 μm and width 500 mm, which was to serve as underfilm, was wound off in front of the front conveyor, fed onto the front conveyor, passed between the calender rolls, and caused to run to the rear conveyor, and this underfilm was used to convey the laminate product.

A sheet of Lumirror #100S10 with a thickness 100 μm and width 500 mm, which was to serve as temporary support, was fed so as to come in contact with the upper roll of the calendering unit, passed between the calender rolls, caused to run to the rear conveyor, and bonded to the underfilm with Rivic Tape (No. 401, supplied by Nitto Denko Corporation) on the rear conveyor. The under film serves as a carrier film that transmit the motion of the conveyor to the support coated with an adhesion layer, and it is removed after this step and will not serve as part of the flexographic printing plate precursor.

The laminate product consisting of an independent sheet and the support prepared in step (7) was attached to the underfilm on the front conveyor with an adhesive cellophane tape in such a manner that the support faces the underfilm, and an appropriate amount of the reactive resin composition prepared by in-line mixing in step (2) was spread over it.

Following this, the temporary support attached on the underfilm was pressed by hand against the rear conveyor so that the driving force of the rear conveyor would be transmitted to the underfilm and the temporary support to cause them to be pulled in the direction from the front conveyor toward the rear conveyor. As the sheets pass between the calendering rolls, the excess amount of the reactive resin composition flow-cast over them that cannot pass through the clearance of the calendering rolls is accumulated at the widthwise edges and on the conveyor on the upstream side of the rolls. The remaining portion that has passed the calendering rolls will serve to form a laminate product with a thickness controlled by the clearance between the calendering rolls.

The resulting laminate product consists of the underfilm, support, adhesion layers, independent sheet prepared in step (6), flow-cast reactive resin composition, and temporary support stacked in this order. Of these, the underfilm and the support are mere polyester films that are not bonded to each other. Over time, the flow-cast reactive resin composition is integrated with the independent sheet prepared in step (6) as the solvent contained in it impregnates the independent sheet prepared in step (6) to form an engraving layer.

Then, the laminate product was stored for a day, and the four peripheral parts of the laminate product (where the sheets and adhesion layer support are absent and the flow-cast reactive resin composition is dominant) were cut off to provide a layered product consisting of a support, adhesion layers, engraving layer, and temporary support. A portion with a width of 2 cm or more are further cut off along each edge to provide a layered product with a top face size of 36 cm×50 cm. The independent sheet prepared in step (6) and the flow-cast reactive resin composition are made up of the same components, and they are integrated to form an engraving layer as the solvent in the reactive resin composition diffuses and moves into the independent sheet prepared in step (6).

### <(9) Step for Further Crosslinking the Engraving Layer>

The resulting layered body was heated in a hot air oven at 100° C. for 3 hours to cause further thermal crosslinking of the engraving layer to provide flexographic printing plate precursor 1 for laser engraving.

### <Evaluation for Thickness Accuracy of Precursor>

Flexographic printing plate precursor 1 for laser engraving was divided into 2 cm×2 cm pieces, and the thickness of each piece was measured after removing the temporary support. Their thickness measurements were 1.13 mm to 1.15 mm, showing a small range of 0.02 mm.

### Comparative Example 1

Without adding the second fluid prepared in Example 1, a cast film was produced only from the first fluid to provide flexographic printing plate precursor 2 for laser engraving.

<(1-1) Preparation of first fluid> was carried out as in Example 1
<Discharge of First Fluid through Coater>

Except that the rate of feeding the first fluid by a gear pump and the rate of feeding the second fluid by a Moineau pump were set to 292 g/min and zero, respectively, the same procedure as for <Discharge of reactive resin composition through coater> in Example 1 was carried out. The injection port for the second fluid was provided with an injection valve to prevent back flow of the first fluid.

<(4) Step for Heating the Cast Film, and (5) Step for Peeling Off the Cast Film from the Release Material to Form an Independent Sheet>

Release material 2 carrying a cast film formed above was heated under either of the two sets of conditions, namely, conditions 1 and conditions 2, specified in Example 1, and after cooling, the cast film was peeled off from release material 2.

The sheet strength of the resulting sheet was measured as in Example 1 to evaluate whether it would serve as an independent sheet, that is, whether the removed sheet would be free of breakage during handling. The sheet prepared under conditions 1 had a sample thickness of 1,080 μm and a sheet strength of less than 0.1 N/cm, and the sheet prepared under conditions 2 had a sample thickness of 1,100 μm and a sheet strength of less than 0.1 N/cm. Both sheets exhibited considerably small values, and did not serve to produce an independent sheet. This is inferred to be because crosslinking reaction proceeded little in the cast film due to the absence of the second fluid that would work to promote the crosslinking reaction of the first fluid, unlike Example 1.

### <Production of Flexographic Printing Plate Precursor for Laser Engraving>

The procedure in Comparative example 1 fails to serve to produce an independent sheet and cannot produce a sheet useful for engraving layer formation. Therefore, the first fluid was cast directly onto support 1 coated with adhesion layers, instead of onto release material 2, and heated in a hot air oven at 100° C. for 60 min and in a hot air oven at 80° C. for 180 min to volatilize the solvent in the cast film, thereby providing a layered product consisting of an engraving layer formed of a cast film, adhesion layers, and a support. The cast film resulting here did not undergo crosslinking and easily suffered from plastic deformation.

Following this, the first fluid, instead of a reactive resin composition formed of a first fluid and a second fluid, was flow-cast over the engraving layer formed of a cast film. Except for this, the same procedure as for <(8) Step for combining a sheet and a temporary support> in Example 1 was carried out to provide a laminate product. The resulting laminate product consists of the underfilm, support, adhesion layers, engraving layer formed of cast film, flow-cast first fluid, and temporary support stacked in this order. Over time, the flow-cast first fluid is integrated with the engraving layer formed of a cast film as the solvent impregnates it, thereby forming an engraving layer.

Following this, the layered body was heated in a hot air oven at 100° C. for 3 hours to produce flexographic printing plate precursor 2 for laser engraving by the same procedure as for <(9) Step for further thermal crosslinking in engraving layer> in Example 1. However, the degree of crosslinking in the engraving layer was not sufficiently low, and it was liable to plastic deformation and was not suitable for flexographic printing.

### Comparative Example 2

A reactive resin composition composed of the same components as in Example 1 was prepared from one fluid, and stored.

### <Step for Preparing Reactive Resin Composition>

After dissolving the polymer, 425 g of a 1:2 mixture of Perbutyl Z and propylene glycol monomethyl ether monoacetate, which were used to prepare the second fluid in Example 1, was added, and except for this, the same procedure as for <(1-1) Preparation of first fluid> in Example 1 was carried out to prepare and store a reactive resin composition.

### <Evaluation for Thermal Stability of Reactive Resin Composition>

As specified for <Evaluation of thermal stability of first fluid> in Example 1, the thermal stability of the reactive resin composition was evaluated based on change in viscosity. The viscosity was 9.5 Pa·s after 30 min following condensation, and the viscosity was more than 20 Pa·s after storage for 3 hours, showing that a large rise in viscosity took place in a short period of time. From the results showing that the physical properties of discharged material change largely and that polymerization products of monomers are highly likely to block the storage container and fluid feeding line, it is obvious that the one-fluid preparation cannot serve successfully for continuous production.

### Example 2

Example 2 used a reactive resin composition composed mainly of a first fluid containing a hydroxyl group-containing compound and a second fluid containing a crosslinking agent.

### <(1-3) Preparation of First Fluid>

The equipment described in Example 1 was used to prepare the first fluid.

The vent valve of the small-scale pressure vessel was opened, and 5.95 kg of propylene glycol monomethyl ether monoacetate (supplied by Daicel Chemical Industries, Ltd.) as solvent, and 2.97 kg of TBC (tributyl citrate, supplied by Kurogane Kasei Co., Ltd.) as plasticizer were added through the material feed port, followed by activating the stirrer blade to rotate at 150 rpm. Then, 4.18 kg of Denka Butyral #3000-2 (polyvinyl butyral, supplied by Denki Kagaku Kogyo Kabushiki Kaisha) was added as hydroxyl group-containing polymer. At this point, the liquid temperature was 25° C.

Subsequently, the bell jar was fixed to the material feed port with bolts and nuts and the vent valve was closed to hermetically seal the pressure vessel. To prevent powder explosion, the nitrogen valve was opened to achieve compression at 0.25 MPa (inner pressure in container at this point 0.35 MPa), and then the vent valve was opened to restore atmospheric pressure (inner pressure in container at this point 0.10 MPa), followed by repeating compression at 0.25 MPa by nitrogen and opening of the vent valve until the reaction container was filled with nitrogen. After filling the reaction container with nitrogen, the vent valve was closed again to hermetically seal it. The rotation of the stirring blade at 150 rpm was continued during this operation.

The warm water valve leading to a 80° C. warm water tank was opened, and a warm water pump was activated to allow warm water to circulate through the outer tank of the reaction container to heat it until the liquid temperature in the reaction container reached 70° C. When a temperature of 70° C. was reached, the temperature setting of the warm water tank was changed to 75° C., and in this state, the stirring blade was continued to rotate at 150 rpm for 120 min to ensure dissolution of the polymer. At this point, the inner temperature of the reaction container was 75° C., and the inner pressure was 0.13 MPa.

After opening the vent valve to return the container's inner pressure to atmospheric pressure (0.10 MPa), the bell jar was removed from the material feed port, and 0.095 kg of DBU (1,8-bicyclo[5.4.0]undecene-7, supplied by Tokyo Chemical Industry Co., Ltd.) as crosslinking catalyst, 0.926 kg of 18% Octope Zn (zinc 2-ethyl hexanoate, supplied by Hope Chemical Co. Ltd.) as sensitization agent to increase the sensitivity to laser engraving, and 0.594 kg of carbon black dispersion liquid 1 as infrared laser absorbent were added from the material feed port.

Following this, the bell jar was fixed to the material feed port with bolts and nuts, and the vent valve was closed to hermetically seal the pressure vessel again. In this state, stirring was continued for 30 min to complete the preparation of the first fluid. At this point, the inner temperature of the reaction container was 75° C., and the inner pressure was 0.10 MPa.

Subsequently, the rotating speed of the stirring blade was adjusted to 40 rpm, and the pressure reducing valve was opened to ensure reduced-pressure deaeration and condensation. The pressure reducing valve is connected to an aspirator via a condensation-cooling pipe and a condensate collecting pipe. The condensation-cooling pipe is a double pipe and serves to circulate 15° C. cooling water through the outer tube.

When reducing the pressure, the pressure reducing valve was opened gradually, and the degree of vacuum was adjusted so that the level of the first fluid would not rise to the upper wall level of the reaction container. When the inner pressure of the pressure vessel reached 0.02 MPa, deaeration had finished almost completely, and the first fluid started to boil. The rotation of the stirring blade was stopped to prevent trapping of bubbles due to stirring. The vapor of the solvent cooled by the condensation-cooling pipe was accumulated in the condensate collecting pipe. Condensation was continued until distillation of 350 mL was achieved, followed by closing the pressure reducing valve and stopping the aspirator. At this point, the inner pressure of the pressure vessel was 0.005 MPa, and the liquid temperature of the first fluid had fallen to 68° C. as a result of removal of heat of evaporation. The liquid distilled out was recovered, and according to measurements made, its weight was 280 g.

Following this, the vent valve was opened to return the inner pressure to atmospheric pressure (0.10 MPa), and nitrogen was supplied for compression up to 0.40 MPa. Subsequently, the temperature of the warm water used as the heating medium for the pressure vessel was changed from 75° C. to 70° C., and the first fluid was stored under this condition.

### <Evaluation of Thermal Stability of First Fluid>

As in Example 1, the viscosity was measured immediately after the completion of condensation (within 1 hour) and after storage for 24 hours, and the thermal stability of the first fluid was evaluated based on the change in viscosity. The viscosity was 10.5 Pa·s after 30 min following condensation, and the viscosity was 10.3 Pa·s after storage for 24 hours. There was no rise in viscosity, indicating that thermal stability was high.

### <(1-4) Preparation of Second Fluid>

KBE-846 (bis(triethoxysilyl propyl) tetrasulfide, supplied by Shin-Etsu Chemical Co., Ltd.) was prepared as crosslinking agent for a hydroxyl group-containing compound. KBE-846 is liquid and therefore, it alone can serve as second fluid. It is not necessary to mix the fluid with other components and therefore, its thermal stability is high when stored in room controlled at 20° C. to 30° C.

<(2) Step for Carrying Out In-Line Mixing of the First Fluid and the Second Fluid to Form a Reactive Resin Composition, and (3) Step for Casting the Reactive Resin Composition onto a Release Material to Form a Cast Film>
<Discharge of Reactive Resin Composition through Coater>

The coater used for discharging the reactive resin composition was the same as that used in Example 1 (coat hanger die). For feeding the first fluid for formation of the reactive resin composition from the storage container to the coat hanger die, the same fluid feeding equipment as in Example 1 was used except for employing a dynamic mixer (provided with star-pin type stirring blade in a vessel of 2.1 L capacity, variable rotating speed from 60 rpm to 600 rpm, supplied by INDAG Maschinenbau GmbH) instead of a static mixer. The second fluid was injected to the fluid feeding line immediately before the dynamic mixer, and an injection valve for preventing back-flow was provided.

The fluid feeding line, filter unit, dynamic mixer, flexible hose, and coat hanger die have structures that can serve to pass a heating medium identical to that for keeping the first fluid at constant temperature, which is 70° C. warm water in this case, so that they can be maintained at the same temperature as its storage temperature. The fluid feeding line, dynamic mixer, and flexible hose have a double pipe structure in which the heating medium and the first fluid pass through the outer tube and the inner tube, respectively. The filter house of the filter unit also has a similar structure. The storage container of the first fluid was constantly pressured at 0.4 MPa by nitrogen in order to achieve forced feeding of the first fluid to the inlet of the gear pump.

The fluid feeding system from the storage container of the second fluid used to form a reactive resin composition to the injection valve provided immediately before the dynamic mixer consisted of a storage container, fluid feeding line, Moineau pump (solution feeding rate variable from 4 cc/min to 50 cc/min, supplied by Heishin Ltd.), fluid feeding line, and injection valve, which are connected in series, and a 200 mesh strainer was provided in the fluid feeding line before the Moineau pump to serve as a foreign object filter for the second fluid. The fluid feeding path was not specially heat-regulated, and maintained at room temperature (20° C. to 30° C.).

A belt conveyor was provided under the coat hanger die, and release material 2 was put on the speed-controlled belt conveyor. A reactive resin composition produced by mixing the first fluid and the second fluid in the dynamic mixer was discharged from the coat hanger die and cast onto release material 2. The rotating speed of the pumps were adjusted so that the gear pump would feed the first fluid at a fluid feeding rate of 202 g/min while the Moineau pump would feed the second fluid at a fluid feeding rate of 45.8 g/min. The rotating speed of the dynamic mixer was set to 250 rpm. The line speed of the belt conveyor was set to 35 cm/min, and a cast film with a thickness of 1,260 μm was discharged onto the release material from the coat hanger die with a discharge width of 45 cm. The resulting cast film had a solvent content of 44 wt %.

<(4) Step for Heating the Cast Film, and (5) Step for Peeling Off the Cast Film from the Release Material to Form an Independent Sheet>

Release material 2 carrying a cast film prepared in step (3) was heated in a hot air oven at 100° C. for 60 min, and then cooled in a room adjusted to a temperature of 20° C. and relative humidity of 65%, followed by peeling off the cast film from release material 2.

The sheet strength of the resulting sheet was measured by the same method as in Example 1 to evaluate whether it would serve as an independent sheet, that is, whether the removed sheet would be free of breakage during handling. The sheet showed a high value of 8.0 N/cm, indicating that an independent sheet was produced successfully.

### Comparative Example 3

Without adding the second fluid prepared in Example 2, a cast film was produced only from the first fluid.

<(1-3) Preparation of first fluid> was carried out as in Example 2
<Discharge of First Fluid through Coater>

Except that the rate of feeding the first fluid by a gear pump and the rate of feeding the second fluid by a Moineau pump were set to 248 g/min and zero, respectively, the same procedure as for <Discharge of reactive resin composition through coater> in Example 2 was carried out. The injection port for the second fluid was provided with an injection valve to prevent back flow of the first fluid.

<(4) Step for Heating the Cast Film, and (5) Step for Peeling Off the Cast Film from the Release Material to Form an Independent Sheet>

Release material 2 carrying a cast film formed above was heated under the same conditions as in Example 2, and after cooling, the cast film was peeled off from release material 2.

The sheet strength of the resulting sheet was measured to evaluate whether it would serve as an independent sheet, that is, whether the removed sheet would be free of breakage during handling. The sheet had a significantly low strength of less than 0.1 N/cm, indicating that an independent sheet was not produced successfully. This is inferred to be because crosslinking reaction proceeded little in the cast film due to the absence of the second fluid that would work to promote the crosslinking reaction of the first fluid, unlike Example 2.

### Comparative Example 4

A reactive resin composition composed of the same components as in Example 2 was prepared from one fluid, and stored.

### <Step for Preparing Reactive Resin Composition>

After dissolving the polymer, 2.97 g of KBE-846, which was used to prepare the second fluid in Example 2, was added, and except for this, the same procedure as for <(1-3) Preparation of first fluid> in Example 2 was carried out to prepare and store a reactive resin composition.

### <Evaluation for Thermal Stability of Reactive Resin Composition>

As specified for <Evaluation of thermal stability of first fluid> in Example 1, the thermal stability of the reactive resin composition was evaluated based on change in viscosity. The viscosity was 6.2 Pa·s after 30 min following condensation, and the viscosity was more than 30 Pa·s after storage for 3 hours, showing that a large rise in viscosity took place in a short period of time. From the results showing that the physical properties of discharged material change largely and that polymerization products of monomers are highly likely to block the storage container and fluid feeding line, it is obvious that the one-fluid preparation cannot serve successfully for continuous production.

### Example 3

Example 3 used a reactive resin composition composed mainly of a first fluid containing an ethylenically unsaturated monomer and a hydroxyl group-containing compound and a second fluid containing a thermal polymerization initiator and crosslinking agent reactive with the hydroxyl group.

### <(1-3) Preparation of First Fluid>

The equipment described in Example 1 was used to prepare the first fluid. The vent valve of the small-scale pressure vessel was opened, and 1.36 g of 4-hydroxy-2,2,6,6-tetramethyl piperidinyl-1-oxyl free radical (supplied by Tokyo Chemical Industry Co., Ltd.) as polymerization inhibitor, 1.68 kg of propylene glycol monomethyl ether monoacetate (supplied by Daicel Chemical Industries, Ltd.) as solvent, 4.20 kg of TBC (tributyl citrate, supplied by Kurogane Kasei Co., Ltd.) as plasticizer, and 5.31 kg of carbon black dispersion liquid 1 as infrared laser absorbent were added through the material feed port, followed by activating the stirrer blade to rotate at 150 rpm. Then, 3.77 kg of Denka Butyral #3000-2 (polyvinyl butyral, supplied by Denki Kagaku Kogyo Kabushiki Kaisha) was added as hydroxyl group-containing compound. At this point, the liquid temperature was 25° C.

Subsequently, the bell jar was fixed to the material feed port with bolts and nuts and the vent valve was closed to hermetically seal the pressure vessel. To prevent powder explosion, the nitrogen valve was opened for compression at 0.25 MPa (inner pressure in container at this point 0.35 MPa), and then the vent valve was opened to restore atmospheric pressure (inner pressure in container at this point 0.10 MPa), followed by repeating compression at 0.25 MPa by nitrogen and opening of the vent valve until the reaction container was filled with nitrogen. After filling the reaction container with nitrogen, the vent valve was closed again to hermetically seal it. The rotation of the stirring blade at 150 rpm was continued during this operation.

The warm water valve leading to a 80° C. warm water tank was opened, and a warm water pump was activated to allow warm water to circulate through the outer tank of the reaction container to heat it until the liquid temperature in the reaction container reached 70° C. When a temperature of 70° C. was reached, the temperature setting of the warm water tank was changed to 75° C., and in this state, the stirring blade was continued to rotate at 150 rpm for 120 min to ensure dissolution of the polymer.

After opening the vent valve to return the inner pressure of the container to atmospheric pressure (0.10 MPa), the bell jar was removed from the material feed port, and 52.4 g of DBU (1,8-bicyclo[5.4.0]undecene-7, supplied by Tokyo Chemical Industry Co., Ltd.) as crosslinked catalyst and 1.57 kg of NK Ester (registered trademark) DCP (tricyclodecane dimethanol dimethacrylate, supplied by Shin-Nakamura Chemical Co., Lid.) as ethylenically unsaturated monomer were added through the material feed port.

Following this, the bell jar was fixed to the material feed port with bolts and nuts, and the vent valve was closed to hermetically seal the pressure vessel again. In this state, stirring was continued for 30 min to complete the preparation of the first fluid. At this point, the inner temperature of the reaction container was 75° C., and the inner pressure was 0.10 MPa.

Subsequently, the rotating speed of the stirring blade was adjusted to 40 rpm, and the pressure reducing valve was opened to ensure deaeration under reduced pressure and condensation. The pressure reducing valve is connected to an aspirator via a condensation-cooling pipe and a condensate collecting pipe. The condensation-cooling pipe is a double pipe and serves to circulate 15° C. cooling water through the outer tube.

Pressure reduction was carried out by the same procedure as in Example 1 except the volume of the distillate was 326 mL. The liquid distilled out was recovered, and according to measurements made, its weight was 260 g.

Following this, the vent valve was opened to return the inner pressure to atmospheric pressure (0.10 MPa), and nitrogen was supplied for compression up to 0.40 MPa. Subsequently, the temperature of the warm water used as the heating medium for the pressure vessel was changed from 75° C. to 70° C., and the first fluid was stored under this condition.

### <Evaluation of Thermal Stability of First Fluid>

As in Example 1, the viscosity was measured after the completion of condensation (within 1 hour) and after storage for 24 hours, and the thermal stability of the first fluid was evaluated based on the change in viscosity. The viscosity was 8.0 Pa·s after 30 min following condensation, and the viscosity was 7.8 Pa·s after storage for 24 hours. There was no rise in viscosity, indicating that thermal stability was high.

### <Preparation of Second Fluid>

A 4.95 kg amount of KBE-846 (bis(triethoxysilyl propyl) tetrasulfide, supplied by Shin-Etsu Chemical Co., Ltd. industry) as crosslinking agent reactive with the hydroxyl group and 2.05 kg of Perbutyl Z (t-butylperoxy benzoate, supplied by NOF Corporation) as thermal polymerization initiator were put in a petroleum can with the inner wall coated with polyethylene film, and mixed by rotating the tightly stopped petroleum can repeatedly for 30 min by “Mazemaze Man” SKH-30 (supplied by Misugi Co., Ltd.) to prepare the second fluid. The second fluid was put in a SUS304 container (capacity 20 L) placed in a room controlled at 20° C. to 30° C., and nitrogen was supplied for compression to 0.20 MPa. The liquid was stored at room temperature.

### <Evaluation for Thermal Stability of Second Fluid>

The viscosity was measured immediately after the completion of mixing (within 1 hour) and after storage for 24 hours, and the thermal stability of the second fluid was evaluated based on the change in viscosity. A Brookfield type viscometer (model BL, supplied by Tokyo Keiki Inc.) was used for viscosity measurement, and a liquid specimen for evaluation was maintained at 25° C. For the evaluation, a No. 2 rotor was used at a rotor rotating speed of 60 rpm.

The viscosity was 0.21 Pa·s both after 30 min following mixing and after storage for 24 hours. There were no changes in viscosity, indicating that thermal stability was high.

<(2) Step for Carrying Out In-Line Mixing of the First Fluid and the Second Fluid to Form a Reactive Resin Composition, and (3) Step for Casting the Reactive Resin Composition onto a Release Material to Form a Cast Film>
<Discharge of Reactive Resin Composition through Coater>

The coater used for discharging the reactive resin composition was the same as that used in Example 1 (coat hanger die). The fluid feeding system from the storage container of the first fluid for reactive resin composition formation to the coat hanger die was the same as that used in Example 2. The second fluid was injected to the fluid feeding line immediately before the dynamic mixer, and an injection valve for preventing back-flow was provided. The fluid feeding system from the storage container of the second fluid for reactive resin composition formation to the injection valve provided immediately before the dynamic mixer was the same as that used in Example 2.

A belt conveyor was provided under the coat hanger die, and release material 2 was put on the speed-controlled belt conveyor. A reactive resin composition produced by mixing the first fluid and the second fluid in the dynamic mixer was discharged from the coat hanger die and cast onto release material 2. The rotating speed of the pumps were adjusted so that the gear pump would feed the first fluid at a fluid feeding rate of 353 g/min while the Moineau pump would feed the second fluid at a fluid feeding rate of 36.3 g/min. The rotating speed of the dynamic mixer was adjusted to 300 rpm. The line speed of the belt conveyor was set to 68 cm/min, and a cast film with a thickness of 1,245 μm was discharged onto the release material from the coat hanger die with a discharge width of 45 cm. The resulting cast film had a solvent content of 30 wt %.

<(4) Step for Heating the Cast Film, and (5) Step for Peeling Off the Cast Film from the Release Material to Form an Independent Sheet>

Release material 2 carrying a cast film prepared in step (3) was heated in a hot air oven at 100° C. for 120 min, and then cooled in a room adjusted to a temperature of 20° C. and relative humidity of 65%, followed by peeling off the cast film from release material 2.

The strength of the resulting sheet was measured by the same method as in Example 1 to evaluate whether it would serve as an independent sheet, that is, whether the removed sheet would be free of breakage during handling. The sheet showed a high value of 10 N/cm, indicating that an independent sheet was produced successfully.

### Comparative Example 5

Without adding the second fluid prepared in Example 3, a cast film was produced only from the first fluid.

<(1-3) Preparation of first fluid> was carried out as in Example 3
<Discharge of First Fluid through Coater>

Except that the rate of feeding the first fluid by a gear pump and the rate of feeding the second fluid by a Moineau pump were set to 389 g/min and zero, respectively, the same procedure as for <Discharge of reactive resin composition through coater> in Example 3 was carried out. The injection port for the second fluid was provided with an injection valve to prevent back flow of the first fluid.

<(4) Step for Heating the Cast Film, and (5) Step for Peeling Off the Cast Film from the Release Material to Form an Independent Sheet>

Release material 2 carrying a cast film formed above was heated under the same conditions as in Example 3, and after cooling, the cast film was peeled off from release material 2.

The strength of the resulting sheet was measured by the same method as in Example 1 to evaluate whether it would serve as an independent sheet, that is, whether the removed sheet would be free of breakage during handling. The sheet showed a significantly poor value of less than 0.1 N/cm, indicating that an independent sheet was not produced successfully. This is inferred to be because crosslinking reaction proceeded little in the cast film due to the absence of the second fluid that would work to promote the crosslinking reaction of the first fluid, unlike Example 3.

### Comparative Example 6

A reactive resin composition composed of the same components as in Example 3 was prepared from one fluid, and stored.

### <Step for Preparing Reactive Resin Composition>

After dissolving the polymer, 1.19 kg of KBE-846 and 0.49 kg of Perbutyl Z, which were used to form the second fluid in Example 3, were added, and except for this, the same procedure as in Example 3 was carried out to prepare and store a reactive resin composition.

### <Evaluation for Thermal Stability of Reactive Resin Composition>

An attempt was made to evaluate the thermal stability of the reactive resin composition based on viscosity change as for <Evaluation for thermal stability of first fluid> in Example 1, but the reactive resin composition had gelated at a point 30 min following the completion of condensation, indicating a considerably inferior thermal stability.

Results of Examples and Comparative examples are summarized in Tables 1 to 3.

TABLE 1

| | | | Comparative | | Comparative | |
|---|---|---|---|---|---|---|
| | Example 1 | | example 1 | | example 2 | |
| Fluid feeding rate of first fluid | 283 | g/min | 292 | g/min | | |
| Ethylenically unsaturated monomer | LMA, M-400 | | | | | |
| Hydroxyl group-containing | Denka Butyral #3000-2 | | | | | |
| compound | | | | | | |
| Crosslinking catalyst | none | | | | | |
| Plasticizer | DCHP | | | | | |
| Polymerization inhibitor | 4-OH-TEMPO | | | | | |
| Sensitization agent to increase | Oct-Zn | | | | | |
| sensitivity to laser engraving | | | | | | |
| Infrared laser absorbent | carbon black (dispersion liquid 1) | | | | | |
| Thermal polymerization initiator | none | | none | | Perbutyl Z | |
| Crosslinking agent reactive with | none | | | | | |
| hydroxyl group | | | | | | |
| Fluid feeding rate of second fluid | 8.7 | g/min | 0 | g/min | | |
| Thermal polymerization initiator | Perbutyl Z | | none | | none | |
| Crosslinking agent reactive with | none | | | | | |
| hydroxyl group | | | | | | |
| Thermal stability of first fluid | good | | good | | Poor | |
| Initial viscosity | 10.0 | Pa · s | 10.0 | Pa ·s | 9.5 | Pa · s |
| Viscosity after 24-hour storage | 9.8 | Pa · s | 9.8 | Pa · s | >20 | Pa · s |

| | | | | | (after 3 h) |
|---|---|---|---|---|---|
| Thermal stability of second fluid | good | | | | |
| Initial viscosity | 3.0 | mPa · s | | | |
| Viscosity after 24-hour storage | 3.0 | mPa · s | | | |
| Conditions for step (4) | conditions 1: 70° C., 180 minutes | | | | |
| | conditions 2: 100° C., 60 minutes | | | | |
| Sheet strength after step (4) | conditions 1: | | conditions 1: | | |
| | <0.1 | N/cm | <0.1 | N/cm | |
| | conditions 2: | | conditions 2: | | |
| | 14 | N/cm | <0.1 | N/cm | |

TABLE 2

| | | | Comparative | | Comparative | |
|---|---|---|---|---|---|---|
| | Example 2 | | example 3 | | example 4 | |
| Fluid feeding rate of first fluid | 202 | g/min | 248 | g/min | | |
| ethylenically unsaturated monomer | none | | | | | |
| hydroxyl group-containing | Denka Butyral #3000-2 | | | | | |
| compound | | | | | | |
| crosslinking catalyst | DBU | | | | | |
| plasticizer | TBC | | | | | |
| polymerization inhibitor | none | | | | | |
| Sensitization agent to increase | Oct-Zn | | | | | |
| sensitivity to laser engraving | | | | | | |
| Infrared laser absorbent | carbon black (dispersion liquid 1) | | | | | |
| thermal polymerization initiator | none | | | | | |
| Crosslinking agent reactive with | none | | none | | KBE-846 | |
| hydroxyl group | | | | | | |
| Fluid feeding rate of second fluid | 45.8 | g/min | 0 | g/min | | |
| thermal polymerization initiator | none | | | | | |
| Crosslinking agent reactive with | KBE-846 | | none | | none | |
| hydroxyl group | | | | | | |
| Thermal stability of first fluid | good | | good | | Poor | |
| Initial viscosity | 10.5 | Pa · s | 10.5 | Pa · s | 6.2 | Pa · s |
| Viscosity after 24-hour storage | 10.3 | Pa · s | 10.3 | Pa · s | >30 | Pa · s |

| | | | | | (after 3 h) |
|---|---|---|---|---|---|
| Thermal stability of second fluid | good | | | | |
| Initial viscosity | (No viscosity | | | | |
| Viscosity after 24-hour storage | change because of | | | | |
| | being 1-component | | | | |
| | fluid) | | | | |
| Conditions for step (4) | 100° | C., | 100° | C., | |
| | 60 | minutes | 60 | minutes | |
| Sheet strength after step (4) | 8.0 | N/cm | <0.1 | N/cm | |

TABLE 3

| | | | Comparative | | Comparative |
|---|---|---|---|---|---|
| | Example 3 | | example 5 | | example 6 |
| Fluid feeding rate of first fluid | 353 | g/min | 3 89 | g/min | |
| ethylenically unsaturated monomer | DCP | | | | |
| hydroxyl group-containing | Denka Butyral #3000-2 | | | | |
| compound | | | | | |
| crosslinking catalyst | DBU | | | | |
| plasticizer | TBC | | | | |
| polymerization inhibitor | 4-OH-TEMPO | | | | |
| Sensitization agent to increase | none | | | | |
| sensitivity to laser engraving | | | | | |
| Infrared laser absorbent | carbon black (dispersion liquid 1) | | | | |
| thermal polymerization initiator | none | | none | | Perbutyl Z |
| Crosslinking agent reactive with | none | | none | | KBE-846 |
| hydroxyl group | | | | | |
| Fluid feeding rate of second fluid | 36.3 | g/min | 0 | g/min | |
| thermal polymerization initiator | Perbutyl Z | | none | | none |
| Crosslinking agent reactive with | KBE-846 | | none | | none |
| hydroxyl group | | | | | |
| Thermal stability of first fluid | good | | good | | poor |
| Initial viscosity | 8.0 | Pa · s | 8.0 | Pa · s | gelated in early |
| Viscosity after 24-hour storage | 7.8 | Pa · s | 7.8 | Pa · s | stage |
| Thermal stability of second fluid | good | | | | |
| Initial viscosity | 0.21 | Pa · s | | | |
| Viscosity after 24-hour storage | 0.21 | Pa · s | | | |
| Conditions for step (4) | 100° | C., | 100° | C., | |
| | 120 | minutes | 120 | minutes | |
| Sheet strength after step (4) | 10 | N/cm | <0.1 | N/cm | |

In Tables 1 to 3, the chemical compounds involved are abbreviated as follows:
4-OH-TEMPO: 4-hydroxy-2,2,6,6-tetramethyl piperidinyl-1-oxyl free radical
DCHP: dicyclohexyl phthalate
LMA: lauryl methacrylate
M-400: dipentaerythritol penta/hexa-acrylate
Oct-Zn: zinc 2-ethyl hexanoate
TBC: tributyl citrate
DBU: 1,8-bicyclo[5.4.0]undecene-7
KBE-846: bis(triethoxysilyl propyl)tetrasulfide
DCP: tricyclodecane dimethanol dimethacrylate

The present invention serves for production of a flexographic printing plate precursor for laser engraving. It also serves for production of letterpress printing plates for laser engraving, intaglio printing plates for laser engraving, stencil printing plates for laser engraving.

### EXPLANATION OF NUMERALS

11: Storage container for first fluid
12: Fluid feeding line for first fluid
13: Fluid conveyor for first fluid
21: Storage container for second fluid
22: Fluid feeding line for second fluid
23: Fluid conveyor for second fluid
31: In-line mixer
32: Coater
33: Conveyor belt
41: Release material
42: Cast film
43: Independent sheet
44: Support
45: Layered body of independent sheet and support
46: Temporary support
47: Flow-cast reactive resin composition
51: Heating device
61, 62, 63, 64: Calendering rolls (or nip rolls)

1. A method for production of a flexographic printing plate precursor for laser engraving comprising at least the following steps to be carried out in this order:
(1) a step for separately preparing a plurality of fluids that are reactive with each other,
(2) a step for carrying out in-line mixing of the plurality of fluids to form a reactive resin composition,
(3) a step for casting the reactive resin composition onto a release material to form a cast film,
(4) a step for heating the cast film, and
(5) a step for removing the cast film from the release material to provide an independent sheet made of the reactive resin composition.

2. The method for production of a flexographic printing plate precursor for laser engraving as defined in claim 1 further comprising (6) a step for heating the independent sheet after step (5).

3. The method for production of a flexographic printing plate precursor for laser engraving as defined in claim 1 wherein the plurality of fluids include a fluid containing an ethylenically unsaturated monomer and a fluid containing a thermal polymerization initiator.

4. The method for production of a flexographic printing plate precursor for laser engraving as defined in claim 1 wherein the plurality of fluids include a fluid containing a hydroxyl group-containing compound and a fluid containing a crosslinking agent that is reactive with the hydroxyl group.

5. The method for production of a flexographic printing plate precursor for laser engraving as defined in claim 2 wherein the plurality of fluids include a fluid containing an ethylenically unsaturated monomer and a fluid containing a thermal polymerization initiator.

6. The method for production of a flexographic printing plate precursor for laser engraving as defined in claim 2 wherein the plurality of fluids include a fluid containing a hydroxyl group-containing compound and a fluid containing a crosslinking agent that is reactive with the hydroxyl group.

7. A method for production of a flexographic printing plate precursor for laser engraving comprising:
(1) separately preparing a plurality of fluids that are reactive with each other,
(2) carrying out in-line mixing of the plurality of fluids to form a reactive resin composition,
(3) casting the reactive resin composition onto a release material to form a cast film,
(4) heating the cast film, and
(5) removing the cast film from the release material to provide an independent sheet made of the reactive resin composition.
